(19) United States
(12) Patent Application Publication
(10) Pub. No.: US 2026/0173167 A1
(43) Pub. Date: Jun. 18, 2026

(54) BLUETOOTH CONNECTION METHOD OF WIRELESS EARPHONE AND WIRELESS EARPHONE

(71) Applicant: SAMSUNG ELECTRONICS CO., LTD., Suwon-si (KR)

(72) Inventors: Ying HUANG, Xia'an (CN); Kun WANG, Xia'an (CN); Taotao DONG, Xia'an (CN); Xulong DU, Xia'an (CN); Qianchung LI, Xia'an (CN)

(73) Assignee: SAMSUNG ELECTRONICS CO., LTD., Suwon-si (KR)

(21) Appl. No.: 19/009,488

(22) Filed: Jan. 3, 2025

(30) Foreign Application Priority Data
Dec. 16, 2024 (CN) 202411855645.3

(51) Int. Cl. H04W 76/10; H04W 4/80

(52) U.S. Cl. CPC H04W 76/10; H04W 4/80; H04R 2420/07

(57) ABSTRACT

Disclosed are a Bluetooth connection method of a wireless earphone and a wireless earphone including a first and a second earphone, and the Bluetooth connection method including: establishing at least one of a first Bluetooth connection and a second Bluetooth connection between a target terminal device and the first earphone; obtaining device information about the target terminal device based on establishing the second Bluetooth connection between the target terminal device and the first earphone; transmitting the device information and connection status information about the first earphone to the second earphone; and transmitting a directed advertisement and a first undirected advertisement or transmitting the first undirected advertisement based on the device information and the connection status information, to establish the second Bluetooth connection between the target terminal device and the second earphone; wherein the device information comprises an address and an Identity Resolution Key of the target terminal device.

### CROSS-REFERENCE TO RELATED APPLICATIONS

This application is a continuation of Chinese Patent Application No. 202411855645.3, filed on Dec. 16, 2024, with the Chinese Intellectual Property Office, the disclosure of which is incorporated herein in its entirety.

### BACKGROUND

The present disclosure relates to Bluetooth communication, and particularly, relates to a Bluetooth connection method of wireless earphones.

With the evolution of Bluetooth technology, Bluetooth audio transmission technology is transitioning from Classic Bluetooth Audio to Low Energy Bluetooth Audio technology, and this transition phase will last for several years or even longer. A dual-mode TWS (True Wireless Stereo) earphone that supports both classic Bluetooth audio and low energy Bluetooth audio can effectively address compatibility issues during this transition phase.

In the classic Bluetooth audio technology, since a protocol specification itself does not consider an application scenario in which an audio data business interaction is performed between a pair of TWS earphones and a same terminal device, various manufacturers adopt private implementation manners on the basis of the classic Bluetooth protocol: one earphone serves as a primary role being responsible for establishing a classic Bluetooth connection with the terminal device, and the other earphone serves as a secondary role. Information is shared through a wireless connection established between primary and secondary earphones, and then classic Bluetooth audio data is obtained through other methods (relay, eavesdropping, etc.).

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure provides a Bluetooth connection method of a wireless earphone and a wireless earphone, which can improve compatibility and stability of a dual-mode TWS earphone, and improve a Bluetooth connection speed and an accuracy of a secondary earphone.

According to an aspect of the present disclosure, there is provided a Bluetooth connection method of a wireless earphone including a first earphone and a second earphone, the Bluetooth connection method including: establishing at least one of a first Bluetooth connection and a second Bluetooth connection between a target terminal device and the first earphone; obtaining device information about the target terminal device based on establishing the second Bluetooth connection between the target terminal device and the first earphone; transmitting the device information and connection status information about the first earphone to the second earphone; and transmitting a directed advertisement and a first undirected advertisement or transmitting the first undirected advertisement based on the device information and the connection status information, to establish the second Bluetooth connection between the target terminal device and the second earphone; wherein the device information comprises an address and an Identity Resolution Key of the target terminal device.

According to an aspect of the present disclosure, there is provided wireless earphone including a first earphone and a second earphone, with the first earphone including at least one first processor and the at least one first processor is configured to: establish at least one of a first Bluetooth connection and a second Bluetooth connection between a target terminal device and the first earphone; in response to establishing the second Bluetooth connection with the target terminal device, obtain device information about the target terminal device; and transmit the device information and connection status information about the first earphone to the second earphone; and the second earphone comprises at least one second processor and the at least one second processor is configured to: transmit a directed advertisement and a first undirected advertisement or transmit the first undirected advertisement based on the device information and the connection status information, to establish the second Bluetooth connection between the target terminal device and the second earphone, wherein the device information comprises an address and an Identity Resolution Key of the target terminal device.

According to an aspect of the present disclosure, there is provided a wireless earphone comprising two earphones, with each of the two earphones including: a first connection manager configured to: establish a wireless connection between a current earphone and another earphone; a second connection manager configured to: establish at least one of a first Bluetooth connection and a second Bluetooth connection between a target terminal device and the current earphone, based on the current earphone being determined as a primary earphone and the another earphone being determined as a secondary earphone, transmit a directed advertisement and a first undirected advertisement or transmit the first undirected advertisement based on device information about the target terminal device and connection status information about the primary earphone, to establish the second Bluetooth connection between the target terminal device and the another earphone; a data transmitter configured to: synchronize data with the another earphone, and obtain the device information about the target terminal device and transmit the device information and the connection status information about the primary earphone to the another earphone, based on the current earphone being determined as the primary earphone; and a data storage configured to: store the device information, the device information comprising an address and an Identity Resolution Key of the target terminal device.

### BRIEF DESCRIPTION OF DRAWINGS

The above and other objects, features and advantages of the present disclosure will become clearer through the following description taken in conjunction with the accompanying drawings, in which:

FIG. 1 illustrates an example of classic Bluetooth connection process in related art;

FIG. 2 illustrates an example of low energy Bluetooth connection process in related art;

FIG. 3 illustrates an example dual-mode Bluetooth connection process in related art;

FIG. 4 illustrates an example of a mixed connection problem caused by the existing dual-mode Bluetooth connection technology;

FIG. 5 is a diagram illustrating an example of a Bluetooth connection process of a wireless earphone according to an embodiment of the present disclosure;

FIG. 6 is a flowchart illustrating a Bluetooth connection process of a wireless earphone according to an embodiment of the present disclosure;

FIG. 7 is a diagram illustrating a flowchart illustrating an exemplary process a first earphone uses to establish a first Bluetooth connection and/or a second Bluetooth connection with a target terminal device and transmit device information during a pairing mode according to an embodiment of the present disclosure;

FIG. 8 is a diagram illustrating a flowchart illustrating an exemplary process a first earphone uses to establish a first Bluetooth connection and/or a second Bluetooth connection with a target terminal device and transmit device information during a recovery mode according to an embodiment of the present disclosure;

FIG. 9 is a diagram illustrating a flowchart illustrating an exemplary process a first earphone uses to establish a first Bluetooth connection and/or a second Bluetooth connection with a target terminal device during a conventional mode according to an embodiment of the present disclosure;

FIG. 10 is a diagram illustrating a flowchart illustrating an exemplary process a second earphone uses to establish a second Bluetooth connection with a target terminal device according to an embodiment of the present disclosure;

FIG. 11 is a diagram illustrating an example of a Bluetooth connection process of a wireless earphone in a pairing mode according to an embodiment of the present disclosure;

FIG. 12 is a diagram illustrating an example of a Bluetooth connection process of a wireless earphone in a recovery mode according to an embodiment of the present disclosure;

FIG. 13 is a diagram illustrating an example of a Bluetooth connection process of a wireless earphone in a conventional mode according to an embodiment of the present disclosure;

FIG. 14 is a diagram illustrating an example of a Bluetooth connection process of a wireless earphone in a single earphone usage scenario according to an embodiment of the present disclosure;

FIG. 15 is a block diagram illustrating a configuration of each of two earphones included in a wireless earphone according to an embodiment of the present disclosure; and

FIG. 16 is a block diagram illustrating a wireless earphone according to an embodiment of the present disclosure.

### DETAILED DESCRIPTION

Hereinafter, various example embodiments of the present disclosure are described with reference to the accompanying drawings, in which like reference numerals are used to depict the same or similar elements, features, and structures. However, the present disclosure is not intended to be limited by the various example embodiments described herein to a specific example embodiment and it is intended that the present disclosure covers all modifications, equivalents, and/or alternatives of the present disclosure, provided that they come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms include plural forms, unless the context clearly indicates otherwise. The terms “include”, “comprise”, and “have” used herein, indicate disclosed functions, operations, or the existence of elements, but do not exclude other functions, operations, or elements.

The expressions “A or B,” or “at least one of A and B” may indicate A and B, A, or B. For instance, the expression “A or B” or “at least one of A and B” may indicate (1) A, (2) B, or (3) both A and B.

In various example embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to” used in describing various embodiments of the present disclosure, may be used interchangeably with expressions such as “suitable for”, “having the capacity to . . . ”, “designed to”, “adapted to”, “made to” and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe example embodiments of the present disclosure, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding example embodiments of the present disclosure.

A Bluetooth connection method for a wireless earphone (which can be interchanged with a Bluetooth earphone hereinafter) is described below.

The existing Bluetooth protocol defines different low energy Bluetooth advertisement types, imposes certain restrictions on the Bluetooth advertisement types transmitted by primary and secondary earphones, and imposes certain constraints on the way in which a terminal device handles different Bluetooth advertisements. This may improve issues of inconsistent connection to some extent. However, these solutions do not solve the fundamental problem, for example, they do not address situations when the connection between the secondary earphone and terminal devices is slow, or when it may be impossible to establish a connection with the terminal device.

The Bluetooth connection method for a wireless earphone in related art first establishes a wireless connection between the primary earphone and the secondary earphone. After entering a pairing stage, a classic Bluetooth connection is established between the primary earphone and the terminal device. Based on this connection, the primary earphone obtains a Bluetooth device Identity Resolution Key and unique device address information of the terminal device and shares them with the secondary earphone. The primary earphone establishes a low energy Bluetooth connection with the terminal device through a directed advertisement, and the secondary earphone establishes the low energy Bluetooth connection with the terminal device through a general advertisement with address filtering manner. While this method can complete a transition from classic Bluetooth audio to low energy Bluetooth audio, this method can only solve the problem of how a dual-mode Bluetooth earphone can connect to a new terminal device during the pairing phase. It does not consider a connection recovery during the subsequent use and a connection issue that may be encountered in a single earphone usage scenario. Moreover, this method relies entirely on the classic Bluetooth connection and cannot be applied to the terminal device that only supports the low energy Bluetooth connection.

Another Bluetooth connection method for the wireless earphone in related art involves transmitting low energy audio advertisement signals from both the primary and secondary earphones to the terminal device during a connection phase. The terminal device establishes both a low energy Bluetooth connection and a classic Bluetooth connection with the primary earphone based on the advertisement signals. The terminal device also determines that the secondary earphone and the primary earphone belong to a same group of Bluetooth devices based on the advertisement signal of the secondary earphone. Thereby establishing the low energy Bluetooth connection with the secondary earphone. However, in this method, the primary and secondary earphones simultaneously transmit the low energy audio advertisement signals, which can lead to inconsistent connections, for example, situations where the primary and secondary earphones connect to different terminal devices.

Another Bluetooth connection method for the wireless earphone in related art can reconnect to a plurality of terminal devices in a same group. This method focuses on how to identify the plurality of terminal devices belonging to the same group, in order to improve a Bluetooth reconnection speed and a reconnection accuracy of the terminal devices. While this method focuses on improving the accuracy of identifying the plurality of terminal devices in the same group from a perspective of the terminal devices to improve the reconnection speed, it does not involve a connection recovery scheme for a dual-mode Bluetooth connection.

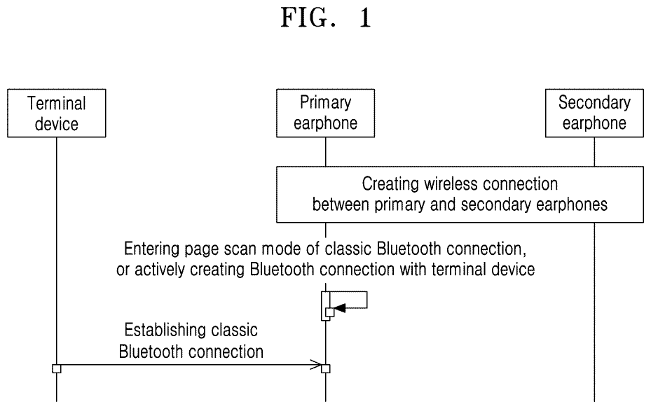

FIG. 1 illustrates an example of a first Bluetooth connection scheme. As shown in FIG. 1, a wireless connection is first created between primary and secondary earphones. Next, the primary earphone enters a page scan mode of the classic Bluetooth connection, or actively creates a Bluetooth connection with the terminal device. In response to the above operations of the primary earphone, the terminal device establishes the classic Bluetooth connection with the primary earphone.

In low energy Bluetooth audio technology, the Bluetooth specification defines the concept of Coordinated Set for the application scenario in which an audio data business interaction is performed between a pair of TWS earphones and a same terminal device. A pair of TWS earphones belonging to the same coordinated set each establishes low energy Bluetooth connection with the terminal device to exchange audio data.

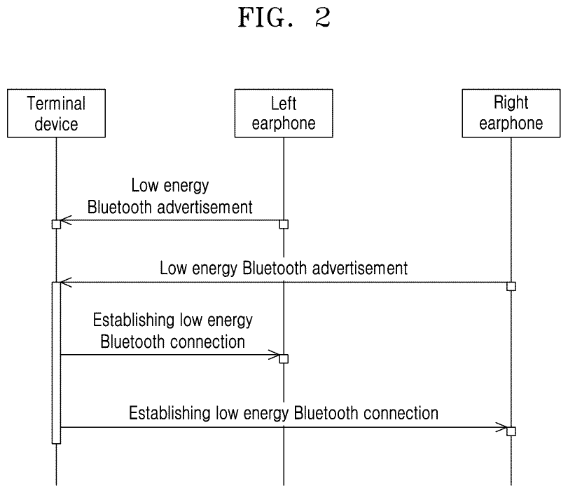

FIG. 2 illustrates an example of a second Bluetooth connection scheme, which may be referred to as a low energy Bluetooth connection scheme. As shown in FIG. 2, left and right earphones respectively transmit a low energy Bluetooth advertisement. The terminal device that receives the low energy Bluetooth advertisement can establish the low energy Bluetooth connections with the left and right earphones.

Dual-mode Bluetooth, as a product of the transition from the classic Bluetooth to the low energy Bluetooth technology, requires the dual-mode TWS earphone to have an ability to establish both classic and low energy Bluetooth connections with the terminal device simultaneously. At present, dual-mode Bluetooth connection technology is not yet fully mature. A simple technical solution is to directly superpose the classic Bluetooth connection technology and the low energy Bluetooth connection technology.

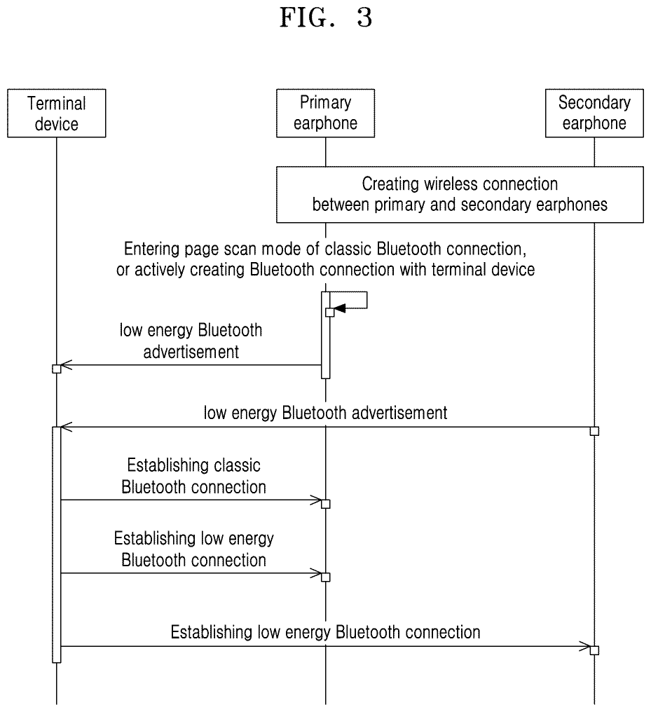

FIG. 3 illustrates an example of a third Bluetooth connection scheme, which may be referred to as a dual-mode Bluetooth connection scheme. As shown in FIG. 3, the wireless connection is first created between the primary and secondary earphones. Next, the primary earphone enters the page scan mode of the classic Bluetooth connection, or actively creates the Bluetooth connection with the terminal device. Subsequently, the primary and secondary earphones respectively transmit the low energy Bluetooth advertisement. In response to the above operations of the primary earphone, the terminal device establishes the classic Bluetooth connection with the primary earphone. However, in response to the low energy Bluetooth advertisement from the primary and secondary earphone, the terminal device may establish a low energy Bluetooth connection with each of the primary and secondary earphones.

By directly superposing the first Bluetooth connection scheme with the second Bluetooth connection scheme, that is, the low energy Bluetooth connection scheme, a goal of simultaneously establishing both the classic Bluetooth and low energy Bluetooth connections with the same terminal device can be achieved. However, the lack of information sharing between the primary and secondary earphones in establishing the classic Bluetooth connection and the low energy Bluetooth connection with the terminal device creates a problem of inconsistent connections. As an example, the left and right earphones may connect to different terminal devices, or that a pair of TWS earphones establish the classic Bluetooth connection with one terminal device and establish the low energy Bluetooth connection with another terminal device.

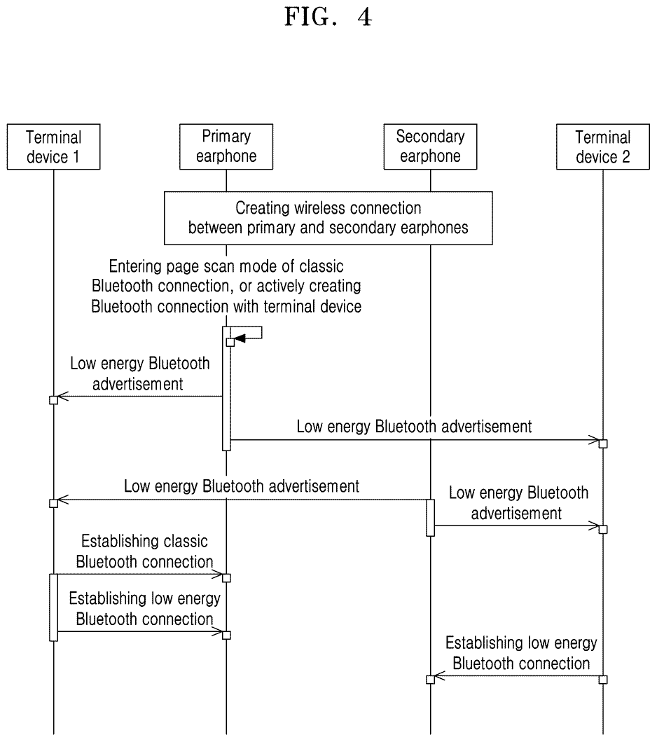

FIG. 4 illustrates an example of a mixed connection problem caused by the dual-mode Bluetooth connection scheme. As shown in FIG. 4, the wireless connection is first created between the primary and secondary earphones. Next, the primary earphone enters the page scan mode of the classic Bluetooth connection, or actively creates the Bluetooth connection with the terminal device. Subsequently, the primary and secondary earphones respectively transmit the low energy Bluetooth advertisement. In response to the above operations of the primary earphone, a terminal device 1 establishes the classic Bluetooth connection with the primary earphone. On the other hand, the terminal device 1 which receives the low energy Bluetooth advertisement from the primary earphone establishes the low energy Bluetooth connection with the primary earphone, and a terminal device 2 that receives the low energy Bluetooth advertisement from the secondary earphone establishes the low energy Bluetooth connection with the secondary earphone. In this case, the primary and secondary earphones establish the low energy Bluetooth connections with different terminal devices, respectively, leading to a problem of the inconsistent connection.

In view of the shortcomings of existing Bluetooth connection methods for various wireless earphones, the present disclosure effectively solves the problem encountered in the dual-mode Bluetooth connection technology by defining a well-defined connection information sharing mechanism between earphones, adding a software logic and a timing control, and defining a connection behavior of the primary and secondary earphones in stages.

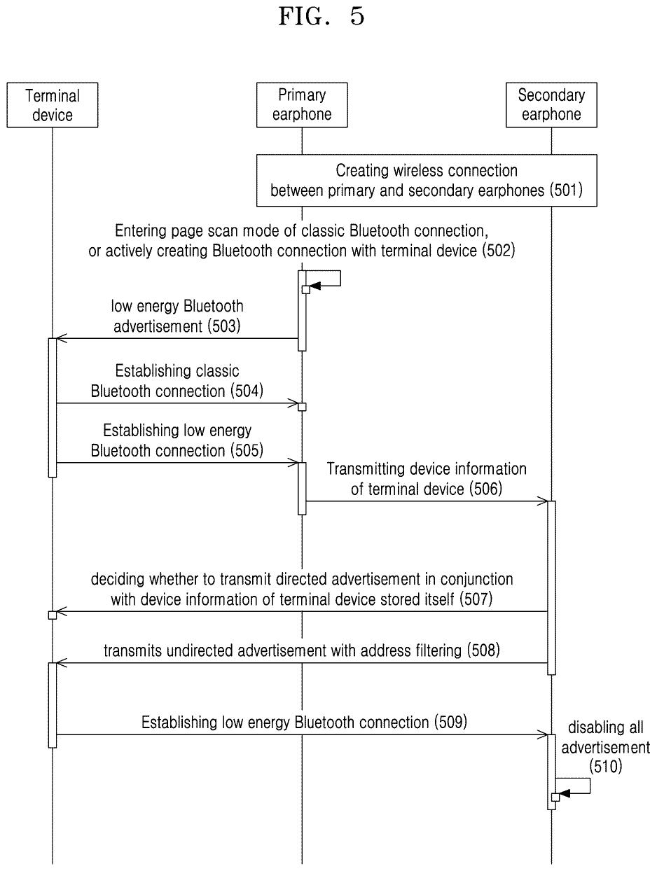

FIG. 5 is a diagram illustrating an example of a Bluetooth connection method of a wireless earphone according to an embodiment of the present disclosure.

Referring to FIG. 5, in operation 501, a wireless connection between two earphones is created, and primary and secondary earphones are decided. According to the embodiment of the present disclosure, a wireless earphone may include two earphones, and when the two earphones create the wireless connection (for example, fetching two earphones from an earphone case), the primary and secondary earphones can be determined between the two earphones based on various preset rules. However, the present disclosure is not limited thereto, and the primary and secondary earphones can be determined between the two earphones at any time. Alternatively, either of the two earphones can be determined as the primary earphone, and the other earphone can be determined as the secondary earphone.

Next, in operation 502, the primary earphone (also referred to herein as the first earphone) can enable an inquiry scan mode and/or a page scan mode of a classic Bluetooth connection, or actively create the classic Bluetooth connection with a terminal device. Meanwhile, in operation 503, the primary earphone can transmit a low energy Bluetooth advertisement.

If the terminal device supports the classic Bluetooth, in operation 504, the terminal device establishes the classic Bluetooth connection with the primary earphone. If the terminal device supports a low energy Bluetooth, in operation 505, the terminal device establishes a low energy Bluetooth connection with the primary earphone.

When the low energy Bluetooth connection is successfully established between the primary earphone and the terminal device, in operation 506, the primary earphone transmits device information of the terminal device including an address and an Identity Resolution Key (IRK) of the terminal device to the secondary earphone. In embodiments, while transmitting the device information of the terminal device to the secondary earphone, the primary earphone also sends its connection status information to the secondary earphone, where the connection status information indicates a number of terminal devices that have currently established a Bluetooth connection with the primary earphone.

After receiving the device information, in operation 507, the secondary earphone decides whether to transmit a directed advertisement of the low energy Bluetooth based on the device information and the device information stored within itself.

Meanwhile, in operation 508, the secondary earphone also needs to add an address of the terminal device to a Filter Accept List (FAL) of device address allowed for connection, and transmits an undirected advertisement with address filtering to the terminal device.

In operation 509, after the terminal device receiving the directed advertisement (e.g., operation 507) and/or the undirected advertisement (e.g., operation 508) transmitted by the secondary earphone, the terminal device establishes the low energy Bluetooth connection with the secondary earphone.

In operation 510, after successfully establishing the low energy Bluetooth connection with the terminal device, the secondary earphone disables the directed advertisement and/or the undirected advertisement (e.g., operation 507 or operation 508).

The above briefly describes an example of the Bluetooth connection method of the wireless earphone according to the embodiment of the present disclosure, additional embodiments of the present disclosure will be described in detail below in conjunction with the accompanying drawings.

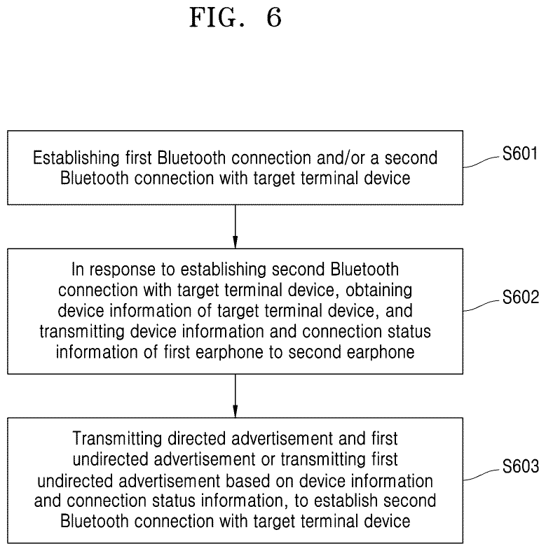

FIG. 6 is a flowchart illustrating a Bluetooth connection method of a wireless earphone according to an embodiment of the present disclosure. Herein, for convenience, two earphones included in the wireless earphone are referred to as a first earphone and a second earphone. However, as described above, any one of the two earphones can serve as the first earphone or the primary earphone. For example, when a left earphone serves as the first earphone, a right earphone will serve as the second earphone, and when the right earphone serves as the first earphone, the left earphone will serve as the second earphone. As another example, when the left earphone serves as a primary earphone, the right earphone may serve as the secondary earphone, and when the right earphone serves as the primary earphone, the left earphone may serve as the secondary earphone.

Referring to FIG. 6, in operation S601, a first Bluetooth connection and/or a second Bluetooth connection with a target terminal device is established, at the first earphone. That is, a first Bluetooth connection may be established between the terminal device and the first earphone, and/or a second Bluetooth connection may be established between the terminal device and the first earphone. Herein, the first Bluetooth connection may represent a classic Bluetooth connection, and the second Bluetooth connection may represent a low energy Bluetooth connection, but the disclosure is not limited thereto.

In response to establishing a wireless connection being established between the first earphone and the second earphone, and the first earphone being selected as a primary earphone based on a preset rule, the first Bluetooth connection and/or the second Bluetooth connection with the target terminal device may be established, at the first earphone. That is, the first Bluetooth connection and/or the second Bluetooth is established between the first earphone and the terminal device. Herein, the preset rule can be various existing rules, and the present disclosure does not impose any restrictions on this. Alternatively, a user can also designate the first earphone as the primary earphone.

In operation S602, in response to establishing the second Bluetooth connection with the target terminal device, device information of the target terminal device is obtained, and the device information and connection status information of the first earphone are transmitted to the second earphone, at the first earphone. That is, in response to the establishment of the second Bluetooth connection between the first earphone and the target terminal device, device information of the target terminal device is obtained, and the device information and connection status information of the first earphone are transmitted to the second earphone, by the first earphone in some embodiments. As described above, the device information includes the address and the Identity Resolution Key IRK of the target terminal device. In addition, as described above, the connection status information of the first earphone can indicate the number of terminal devices that have currently established a Bluetooth connection with the primary earphone.

Specifically, in response to establishing a wireless connection with the second earphone and being selected as the primary earphone based on the preset rule, the device information and the connection status information of the first earphone can be transmitted to the second earphone, at or by the first earphone. When the first and second earphones are not in a working state at the same time, or when the first and second earphones are not within a coverage range of a counterpart's wireless signal, the first and second earphones cannot establish the wireless connection. At this point, the first earphone is used alone and establishes the second Bluetooth connection with the target terminal device. In this case, when the second earphone enters the working state and enters the coverage range of wireless signal of the first earphone, the first earphone can establish the wireless connection with the second earphone and transmits the device information and its connection status information to the second earphone as the primary earphone. Accordingly, the Bluetooth connection method of the wireless earphone according to the embodiment of the present disclosure may be applicable to a single earphone usage scenario.

According to the embodiment of the present disclosure, a connection behavior between the first earphone and the terminal device (hereinafter referred to as a connection mode of the first earphone) can be divided into three stages or modes, i.e. a pairing stage or mode, a recovery stage or mode, and a conventional stage or mode.

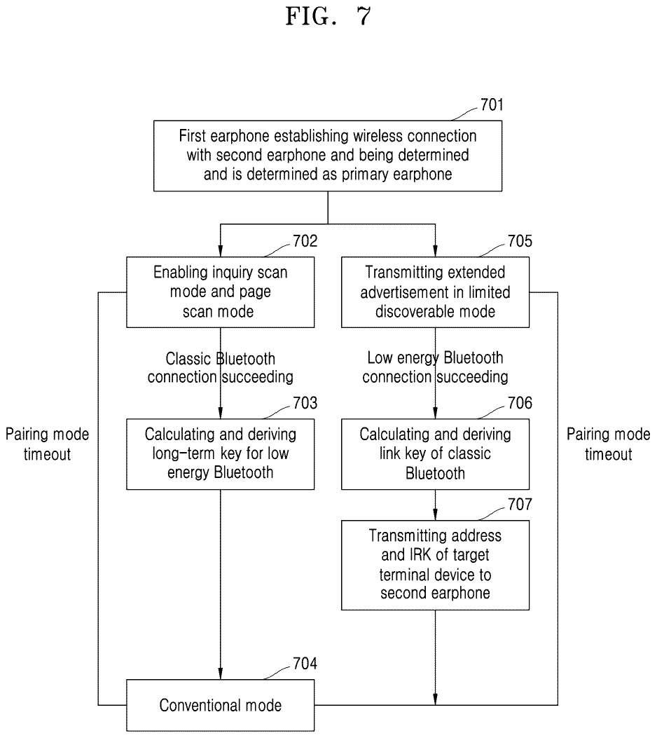

FIG. 7 is a diagram illustrating an example that a first earphone establishes a first Bluetooth connection and/or a second Bluetooth connection with a target terminal device and transmits device information during a pairing mode. It will be understood that the first Bluetooth connection may represent a classic Bluetooth connection and the second Bluetooth connection may represent a low energy Bluetooth connection, but the disclosure is not limited thereto.

Referring to FIG. 7, in operation 701, the first earphone establishes a wireless connection with the second earphone and is determined as a primary earphone. Subsequent to operation 701, in operation 702, the first earphone enables an inquiry scan mode and a page scan mode to establish a first Bluetooth connection with the target terminal device. The inquiry scan mode and the page scan mode are collectively referred to as an inquiry scan and page scan mode. In operation 703, when the first Bluetooth connection is successfully established between the first earphone and the terminal device, the first earphone calculates and derives a long-term key for low energy Bluetooth. Subsequently, in operation 704, the first earphone enters a conventional mode.

On the other hand, subsequent to operation 701, in operation 705, the first earphone transmits an extended advertisement in a limited discoverable mode (hereinafter referred to as a second undirected advertisement) to establish a second Bluetooth connection with the target terminal device. Operation 702 and operation 705 can be executed simultaneously. In operation 706, when the second Bluetooth connection is successfully established, the first earphone calculates and derives a link key of classic Bluetooth. In operation 707, the first earphone transmits an address and an Identity Resolution Key of the target terminal device to the second earphone. In addition, in operation 707, the first earphone also transmits its connection status information to the second earphone, which indicates the number of terminal devices that have currently established a Bluetooth connection with the first earphone. Subsequently, in operation 704, the first earphone enters the conventional stage.

Herein, after the first earphone enables the inquiry scan and page scan mode and transmits the second undirected advertisement, an order in which the terminal device establishes the first Bluetooth connection and the second Bluetooth connection with the first earphone depends on the terminal device's own settings or a user choice. Alternatively, if the first earphone fails to establish the first Bluetooth connection with the target terminal device within a first predetermined time after enabling the inquiry scan and page scan mode (i.e. a pairing mode timeout), or if the first earphone fails to establish the second Bluetooth connection with the target terminal device within a second predetermined time after transmitting the second undirected advertisement (i.e. the pairing mode timeout), the first earphone will also enter the conventional phase. Accordingly, when the first earphone fails to establish the Bluetooth connection (such as the first Bluetooth connection or the second Bluetooth connection) with the terminal device during the pairing phase, the first earphone will enter the conventional phase. Herein, the first predetermined time may be the same or different from the second predetermined time, and the present disclosure does not impose any restrictions on this.

Therefore, in response to a connection mode being the pairing mode, the inquiry scan and page scan mode may be enabled to establish the first Bluetooth connection between the first earphone and the target terminal device, and/or the second undirected advertisement can be transmitted to establish the second Bluetooth connection between the first earphone and the target terminal device, by the first earphone.

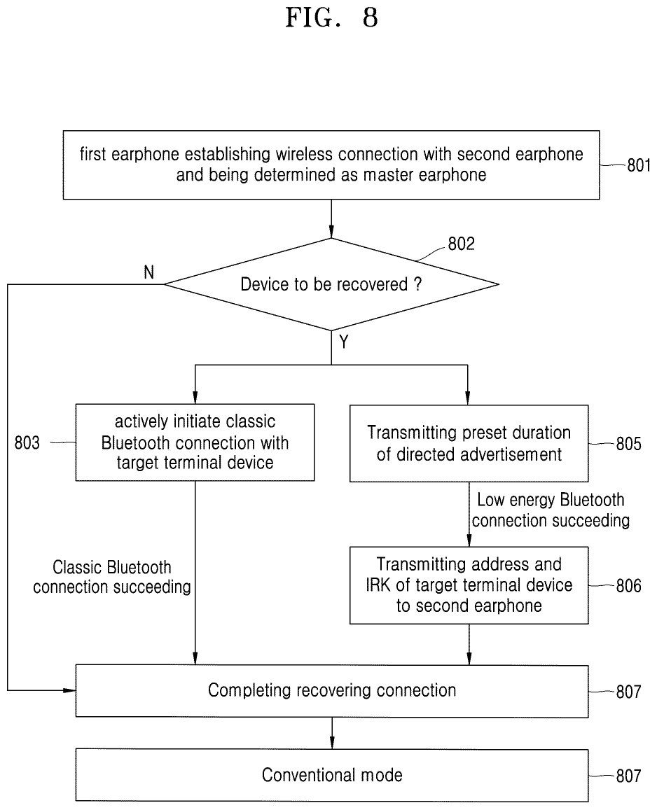

FIG. 8 is a diagram illustrating an example that a first earphone establishes a first Bluetooth connection and/or a second Bluetooth connection with a target terminal device and transmits device information during a recovery mode. It will be understood that the first Bluetooth connection may represent a classic Bluetooth connection and the second Bluetooth connection may represent a low energy Bluetooth connection, but the disclosure is not limited thereto.

Referring to FIG. 8, in operation 801, the first earphone establishes a wireless connection with the second earphone and is determined as a primary earphone. In operation 802, the first earphone determines whether there is a target terminal device for which a connection is to be recovered.

When it is determined that there is the target terminal device for which the connection is to be recovered, in operation 803, the first earphone can actively initiate a first Bluetooth connection with the target terminal device, thereby establishing the first Bluetooth connection with the target terminal device. When the first Bluetooth connection is successfully established, in operation 804, the first earphone confirms that the connection is recovered.

In some embodiments, when it is determined that there is the target terminal device for which the connection is to be recovered, in operation 805, the first earphone transmits a preset duration of directed advertisement to establish a second Bluetooth connection with the target terminal device. Herein, a destination address for the directed advertisement is an address of the target terminal device for which the connection is to be recovered. In operation 806, when the second Bluetooth connection is successfully established, the first earphone transmits an address and an Identity Resolution Key of the target terminal device to the second earphone, and in operation 804, the first earphone confirms that the connection is recovered. Additionally, in operation 806, the first earphone may also transmit its connection status information to the second earphone. Alternatively, when it is determined that there is no target terminal device for which a connection is to be recovered, or when a duration of the recovery mode has passed and no connection with any target terminal device has been recovered, the first earphone will also confirm that the connection is recovered. Next, in operation 807, the first earphone enters a conventional stage.

Therefore, in an embodiment, in response to a connection mode being the recovery mode, the first Bluetooth connection with the target terminal device is actively initiated and/or the preset duration of directed advertisement is transmitted to establish the second Bluetooth connection with the target terminal device, at the first earphone. In this way, the first earphone can adopt different connection strategies for the pairing mode and the recovery mode to establish the second Bluetooth connection with the target terminal device, thereby improving a connection speed and a success rate of connection.

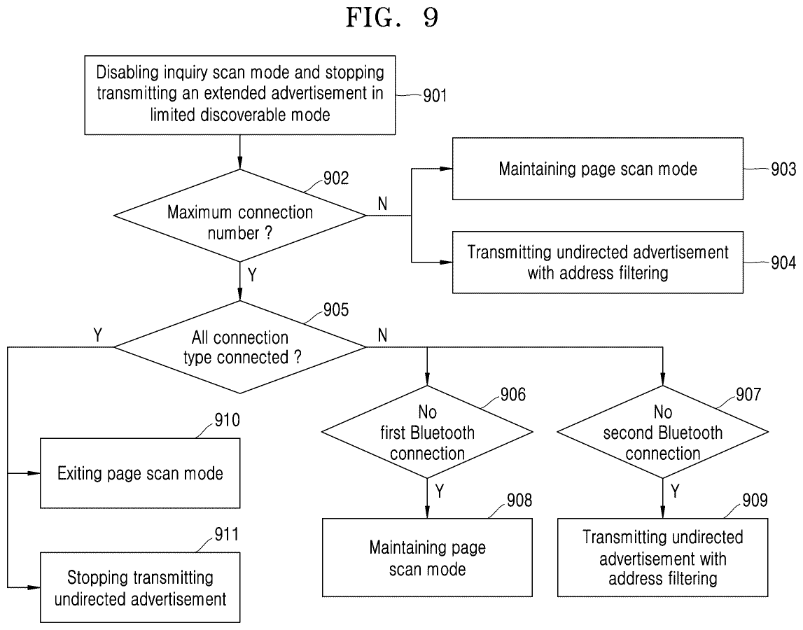

FIG. 9 is a diagram illustrating an example that a first earphone establishes a first Bluetooth connection and/or a second Bluetooth connection with a target terminal device during a conventional mode. It will be understood that the first Bluetooth connection may represent a classic Bluetooth connection and the second Bluetooth connection may represent a low energy Bluetooth connection, but the disclosure is not limited thereto. As described above, when a recovery mode ends, regardless of whether the first earphone successfully establishes a Bluetooth connection with the target terminal device, the first earphone will enter the conventional phase. According to an embodiment, when a pairing mode ends, regardless of whether the first earphone successfully establishes the Bluetooth connection with the target terminal device, the first earphone will also enter the conventional phase.

Referring to FIG. 9, in operation 901, the first earphone is no longer allowed to be discovered by new terminal devices in the conventional mode, and accordingly, the first earphone needs to disable an inquiry scan mode and stop transmitting an extended advertisement in a limited discoverable mode (i.e. a second undirected advertisement). In operation 902, the first earphone determines whether the number of all target terminal devices which have connected to it has reached a maximum connection number (e.g., a first threshold). When the number of the target terminal devices which have connected to the first earphone does not reach the maximum connection number, one operation that may be performed includes operation 903, where the first earphone maintains a page scan mode to establish the first Bluetooth connection with respective target terminal devices previously connected to the first earphone. When the number of the target terminal devices which have connected to the first earphone does not reach the maximum connection number, another operation that may be performed includes operation 904 (which may be performed at the same time) where the first earphone transmits a first undirected advertisement and adds addresses of the respective target terminal devices previously connected to it to a Filter Accept List of device address, so as to establish the second Bluetooth connection with the respective target terminal devices previously connected to the first earphone.

The “connection” described herein refers to the Bluetooth connection, including the first Bluetooth connection and the second Bluetooth connection. Therefore, the number of all target terminal devices which have connected to the first earphone may include a sum of the number of the target terminal devices which have only established the first Bluetooth connection with the first earphone, the number of the target terminal devices which have only established the second Bluetooth connection with the first earphone, and the number of the target terminal devices which have established the first Bluetooth connection and the second Bluetooth connection with the first earphone.

Therefore, in response to the first earphone not successfully establishing the first Bluetooth connection and/or the second Bluetooth connection with the target terminal device, the inquiry scan mode is disabled, a transmission of the second undirected advertisement is stopped, and the number of all target terminal devices which have connected to the first earphone is determined, at or by the first earphone. Subsequently, in response to the number of all target terminal devices which have connected to the first earphone being less than the first threshold, the page scan mode is maintained to establish the first Bluetooth connection with the respective target terminal devices previously connected to the first earphone, and/or the first undirected advertisement is transmitted and the addresses of the respective target terminal devices previously connected to the first earphone are added to the Filter Accept List of device address. This is done establish the second Bluetooth connection with the respective target terminal devices previously connected to the first earphone, at or by the first earphone. While, the first earphone attempts to establish the first Bluetooth connection/second Bluetooth connection with the respective target terminal devices previously connected to it, but it does not mean that the first earphone must establish the first Bluetooth connection/second Bluetooth connection with all target terminals previously connected to it.

In this way, the first earphone can adopt different connection strategies for the pairing mode, the recovery mode, and the conventional mode, to establish the second Bluetooth connection with the target terminal device, improving a connection speed and a success rate of connection. Furthermore, the first earphone can also attempt to establish the Bluetooth connections with the respective target terminal devices previously connected to it, further improving connection efficiency and the success rate of connection.

Referring to FIG. 9 again, at operation 902, when the number of all target terminal devices which have connected to the first earphone reaches the maximum connection number, the process proceeds to operation 905. In operation 905, the first earphone determines whether all connection types with the respective target terminal devices which have connected to it have been connected. When all connection types between the first earphone and the respective target terminal devices have not been connected, in operation 906, the first earphone determines whether the first Bluetooth connection with the respective target terminal devices has not been established, and in operation 907, the first earphone determines whether the second Bluetooth connection with the respective target terminal devices has not been established. It may be noted that operations 906 and 907 may be performed in parallel. At operation 906, when it is determined that the first earphone has not established the first Bluetooth connection with at least one target terminal device, in operation 908, the first earphone maintains the page scan mode to establish the first Bluetooth connection with at least one target terminal device that has not established the first Bluetooth connection. On the other hand, at operation 907, when it is determined that the first earphone has not established the second Bluetooth connection with at least one target terminal device, in operation 909, the first earphone transmits the first undirected advertisement and adds an address of at least one target terminal device that has not established the second Bluetooth connection to the Filter Accept List of device address, so as to establish the second Bluetooth connection with the at least one target terminal device that has not established the second Bluetooth connection.

Therefore, in response to the number of the target terminal devices which have connected to the first earphone reaching the first threshold, the connection type between the first earphone and respective connected target terminal devices is determined at or by the first earphone. Further, in response to the connection type between the first earphone and at least one target terminal device being only the first Bluetooth connection, the first undirected advertisement is transmitted and the address of the at least one target terminal device is added to the Filter Accept List of device address, to establish the second Bluetooth connection with the at least one target terminal device at or by the first earphone. In another or same embodiment, in response to the connection type between the first earphone and at least one target terminal device being only the second Bluetooth connection, the page scan mode is maintained to establish the first Bluetooth connection with the at least one target terminal device at or by the first earphone. Therefore, the first earphone can attempt to establish various types of Bluetooth connections with the respective target terminal devices previously connected to it, improving the connection efficiency and the success rate of connection.

Referring to FIG. 9 again, when all connection types with the respective target terminal devices have been connected at the first earphone in operation 902, in operation 910, the first earphone may exit the page scan mode, and in operation 911, the first earphone stops transmitting the first undirected advertisement. Therefore, in response to the connection type between the first earphone and the respective connected target terminal devices being the first Bluetooth connection and the second Bluetooth connection, the page scan mode is disabled and the transmission of the first undirected advertisement is stopped, at the first earphone.

Referring to FIG. 6 again, in operation 603, a directed advertisement and the first undirected advertisement are transmitted or the first undirected advertisement is transmitted based on the device information and the connection status information of the first earphone, to establish the second Bluetooth connection between the target terminal device and the second earphone, at or by the second earphone.

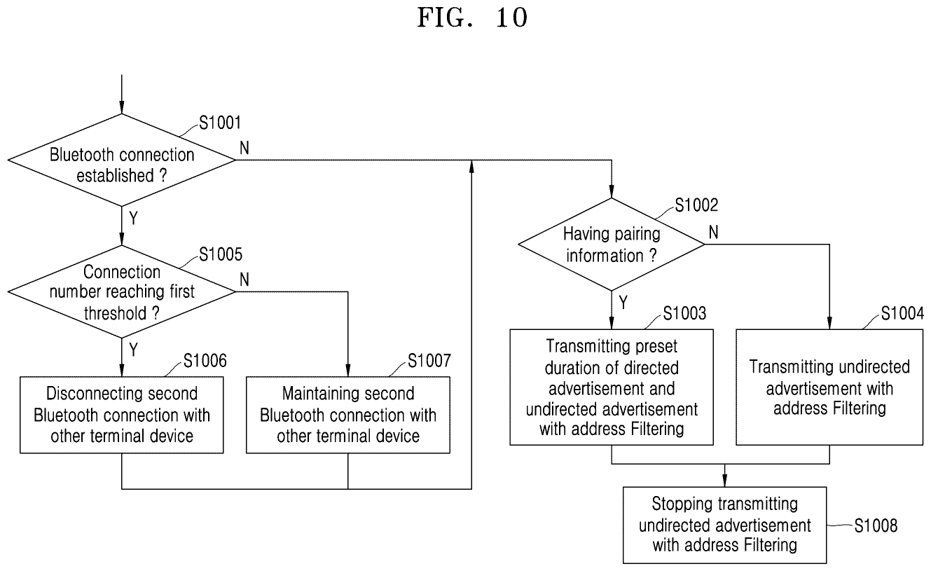

An operation that the second earphone establishes the second Bluetooth connection with the target terminal device is described below with reference to FIG. 10. FIG. 10 is a diagram illustrating an example of establishing a second Bluetooth connection with a target terminal device at a second earphone according to an embodiment of the present disclosure.

Referring to FIG. 10, in operation S1001, it is determined whether the second Bluetooth connection has been established between other terminal device and the second earphone, at or by the second earphone.

When the second earphone does not establish the second Bluetooth connection with the other terminal device, in operation S1002, the second earphone determines whether it has pairing information of the target terminal device. In the case that the second earphone has previously established the second Bluetooth connection with the target terminal device, the second earphone will save the pairing information of the target terminal device. Therefore, when the second earphone has the pairing information of the target terminal device, in operation S1003, the second earphone transmits a preset duration of directed advertisement based on the pairing information, while also transmits a first undirected advertisement and adds an address of the target terminal device to a Filter Accept List of device address, to establish the second Bluetooth connection with the target terminal device.

On the other hand, when the second earphone does not have the pairing information of the target terminal device at operation S1002, in operation S1004, the second earphone transmits the first undirected advertisement and adds the address of the target terminal device to the Filter Accept List of device address, to establish the second Bluetooth connection with the target terminal device. Accordingly, when the second earphone has the pairing information, the second earphone can simultaneously transmit the directed advertisement and a undirected advertisement with address filtering, to quickly and accurately establish the second Bluetooth connection with the target terminal. In addition, in order to reduce power consumption, if the second Bluetooth connection is not established with the target terminal device within a preset time, a transmission of the directed advertisement will be stopped.

In operation S1001, when the second earphone has established the second Bluetooth connection with the other terminal device, then, in operation S1005, the second earphone determines whether the number of all target terminal devices which have connected to the first earphone indicated by the connection status information reaches a first threshold. When, in operation S1005, the number of all target terminal devices which have connected to the first earphone indicated by the connection status information reaches the first threshold, in operation S1006, the second earphone disconnects the second Bluetooth connection with the other terminal device, and then returns to operation S1002 to determine whether it has the pairing information of the target terminal device.

On the other hand, when, in operation S1005, the number of all target terminal devices which have connected to the first earphone indicated by the connection status information is less than or equal to the first threshold, in operation S1007, the second earphone maintains the second Bluetooth connection with the other terminal device, and then returns to operation S1002 to determine whether it has the pairing information of the target terminal device. Therefore, when the second earphone establishes the second Bluetooth connection with the other terminal device and the number of target terminal devices which have connected to the first earphone reaches an upper limit, in order to avoid a inconsistent connections of the first earphone and the second earphone, the second earphone needs to first disconnect the second Bluetooth connection with the connected terminal device and establish the second Bluetooth connection with the target terminal devices by transmitting the directed advertisement and/or the undirected advertisement with the address filtering. This ensures that the connection status of the two earphones is always consistent.

On the other hand, in a case where the second earphone establishes the second Bluetooth connection with the other terminal device and the number of target terminal devices which have connected to the first earphone does not reach the upper limit, the second earphone can maintain the second Bluetooth connection with the connected terminal device, and the first earphone can attempt to establish the second Bluetooth connection with the terminal device in a conventional mode. It should be noted that the other terminal devices which have established the second Bluetooth connection with the second earphone must be a device that have previously established a Bluetooth connection with the first and second earphones. Therefore, the first earphone must have the pairing information of the other terminal device that establishes the second Bluetooth connection with the second earphone, so that the first earphone can attempt to establish the second Bluetooth connection with the terminal device in the conventional mode.

In other words, the operation of establishing the second Bluetooth connection between the second earphone and the target terminal device may include: determining whether the second earphone has pairing information of the target terminal device, at or by the second earphone. In response to having the pairing information of the target terminal device, the operation of establishing the second Bluetooth connection between the second earphone and the target terminal device may include: transmitting a preset duration of directed advertisement based on the pairing information, while transmitting the first undirected advertisement and adding an address of the target terminal device to a Filter Accept List of device address, to establish the second Bluetooth connection with the target terminal device, at or by the second earphone. In response to having no the pairing information of the target terminal device, the operation of establishing the second Bluetooth connection between the second earphone and the target terminal device may include: transmitting the first undirected advertisement and adding the address of the target terminal device to the Filter Accept List of device address, to establish the second Bluetooth connection with the target terminal device, at the second earphone.

In a same or another embodiment, the operation of establishing the second Bluetooth connection between the second earphone and the target terminal device may further include: determining whether the second Bluetooth connection has been established with the other terminal device, at or by the second earphone. Afterwards, in response to not establishing the second Bluetooth connection with the other terminal device, it is determined whether the second earphone has the pairing information of the target terminal device, at or by the second earphone.

In a same or another embodiment, the operation of establishing the second Bluetooth connection between the second earphone and the target terminal device may further include: in response to establishing the second Bluetooth connection with the other terminal device, determining whether the number of all target terminal devices connected to the first earphone indicated by the connection status information reaches the first threshold, at or by the second earphone. In response to the connection status information indicating that the number of all target terminal devices connected to the first earphone reaches the first threshold, the operation of establishing the second Bluetooth connection between the second earphone and the target terminal device may further include: disconnecting the second Bluetooth connection with the other terminal device, at the second earphone. In embodiments, in response to the connection status information indicating that the number of all target terminal devices connected to the first earphone is less than or equal to the first threshold, the operation of establishing the second Bluetooth connection between the second earphone and the target terminal device may further include: maintaining the second Bluetooth connection with other terminal device, at the second earphone. Afterwards, after disconnecting the second Bluetooth connection with the other terminal device or after maintaining the second Bluetooth connection with the other terminal device, it is determined whether the second earphone has the pairing information of the target terminal device, at or by the second earphone.

Referring to FIG. 10 again, when the second earphone establishes the second Bluetooth connection with the target terminal device, in operation S1008, the second earphone can stop transmitting the first undirected advertisement, thereby further reducing the power consumption of the Bluetooth connection.

The Bluetooth connection method of the wireless earphone according to the embodiment of the present disclosure may further include the following steps: when the first earphone disconnects the second Bluetooth connection with the target terminal device, the first earphone can transmit the device information and its connection status information to the second earphone. For example, when the first earphone disconnects the second Bluetooth connection with the target terminal device, the second earphone does not need to synchronously disconnect the second Bluetooth connection with the target terminal device, but can independently determine whether to disconnect the second Bluetooth connection with the target terminal device. As another example, the second earphone may disconnect the second Bluetooth connection with the target terminal device in response to a user operation, may disconnect the second Bluetooth connection with the target terminal device in response to the target terminal device exceeding a Bluetooth connection range, and may disconnect the second Bluetooth connection with the target terminal device in response to being placed in an earphone case. It will be understood that a situation where the second earphone disconnects the second Bluetooth connection with the target terminal device is not limited to situations described above.

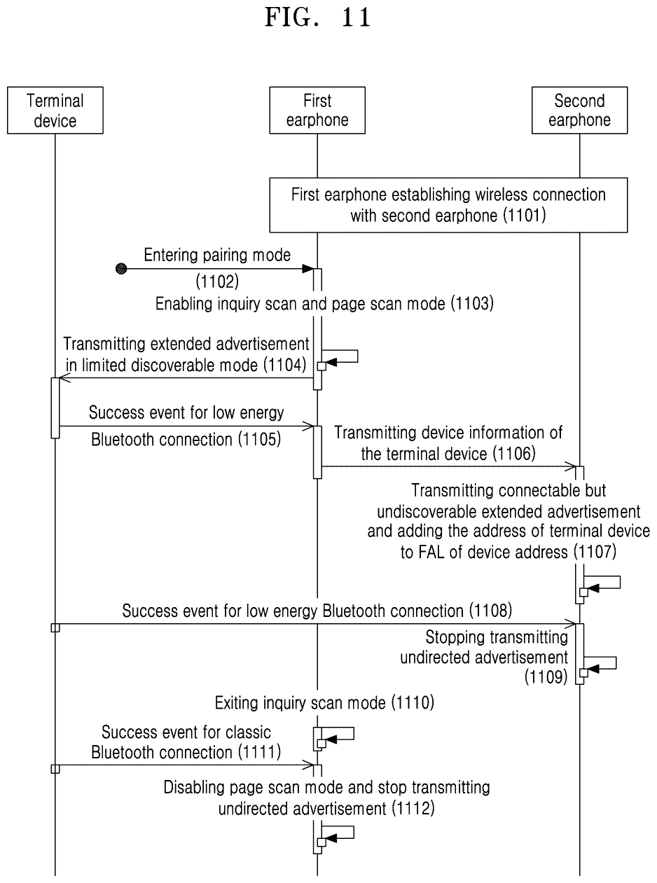

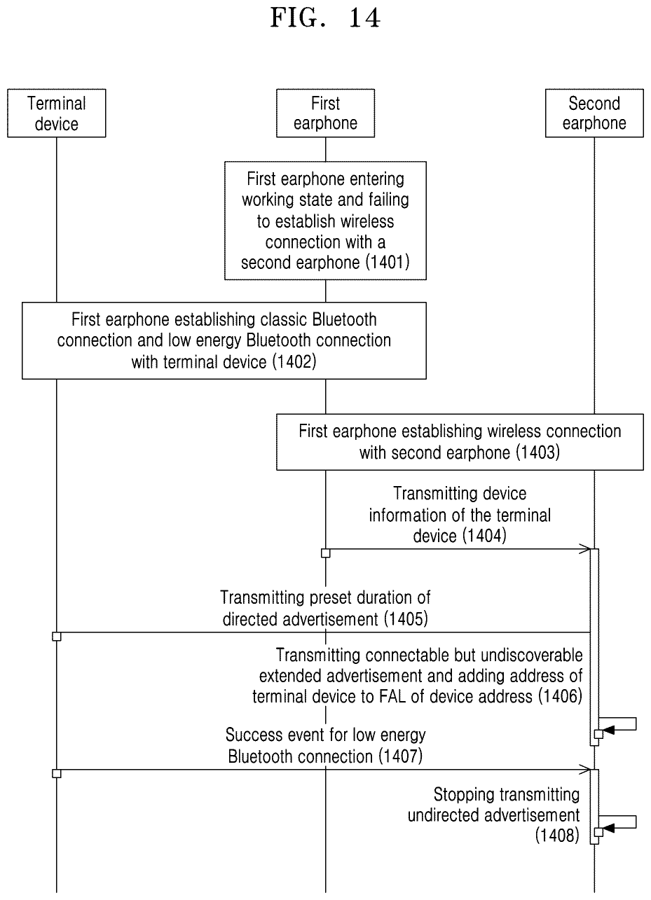

Examples of the Bluetooth connection method of the wireless earphone in the pairing mode, the recovery mode, and the conventional mode are described below in conjunction with FIGS. 11 to 13, and an example of the Bluetooth connection method of the wireless earphone in the single earphone usage scenario is described below in conjunction with FIG. 14.

FIG. 11 is a diagram illustrating an example of a Bluetooth connection method of a wireless earphone in a pairing mode according to an embodiment of the present disclosure.

Referring to FIG. 11 in operation 1101, after the wireless earphone enters a working state (for example, fetching two earphones from an earphone case), if the two earphones are within a coverage range of a counterpart's wireless signal, a wireless connection (for example, but not limited to a Bluetooth connection) is established between the first earphone and the second earphone, and primary and secondary earphones are decided based on a preset rule. In an embodiment, it is described that the first earphone serves as the primary earphone; however, the present disclosure is not limited thereto. The second earphone can also serve as the primary earphone. It will be understood that the names of the first earphone and the second earphone may be simply exchanged.

Subsequently, in operation 1102, the first earphone may decide whether to enter the pairing mode based on the scene (for example, the first earphone enters the pairing mode upon first using or performing factory reset), or a user may trigger the first earphone to enter the pairing mode when needed.

After the first earphone enters the pairing mode, in operation 1103, the first earphone enables an inquiry scan and page scan mode of a classic Bluetooth connection to establish the classic Bluetooth connection with the terminal device. At the same time or subsequently, in operation 1104, the first earphone transmits an extended advertisement in a limited discoverable mode of a low energy Bluetooth connection to establish the low energy Bluetooth connection with the terminal device. At this point, the user can scan a wireless earphone on a terminal device that has not been paired with the wireless earphone, and click to connect. Subsequently, in operation 1105, the first earphone successfully establishes the low energy Bluetooth connection with the terminal device and receives a success event for the low energy Bluetooth connection. In operation 1106, the first earphone transmits an address and an Identity Resolution Key of the terminal device to the second earphone through the wireless connection between the two earphones, and then enters a conventional mode. In addition, in operation 1106, the first earphone also transmits its connection status information to the second earphone.

In operation 1107, when the second earphone receives the address and Identity Resolution Key of the terminal device, the second earphone transmits a connectable but undiscoverable extended advertisement (i.e., an undirected advertisement) and adds the address of the terminal device to a Filter Accept List of device address, to establish the low energy Bluetooth connection with the terminal device. At this point, the terminal device actively establishes the low energy Bluetooth connection with the second earphone after scanning the undirected advertisement transmitted by the second earphone. In operation 1108, the second earphone is paired with the terminal device to successfully establish the low energy Bluetooth connection, and the second earphone receives a success event for the low energy Bluetooth connection. Subsequently, in operation 1109, since the second earphone has connected to the terminal device simultaneously with the first earphone, the second earphone stops transmitting the undirected advertisement.

In operation 1110, the first earphone is no longer allowed to be discovered by new terminal devices in the conventional mode, and accordingly the first earphone exits an inquiry scan mode. Meanwhile, if the wireless earphone supports a multi-device connection, the first earphone can maintain a page scan mode to allow for establish the classic Bluetooth connection with other terminal device. In operation 1111, the first earphone establishes the classic Bluetooth connection with the other terminal device and the first earphone receives a success event for the classic Bluetooth connection. Meanwhile, the first earphone also transmits the connectable but undiscoverable extended advertisement and adds addresses of all terminal devices paired with the wireless earphone to the Filter Accept List of device address, to establish the low energy Bluetooth connection with the other terminal device. When the number of terminal devices connected to the first earphone reaches a maximum number and the first earphone establishes the Bluetooth connections with the terminal devices in all Bluetooth connection manners, in operation 1112, the first earphone can disable the page scan mode and stop transmitting the undirected advertisement.

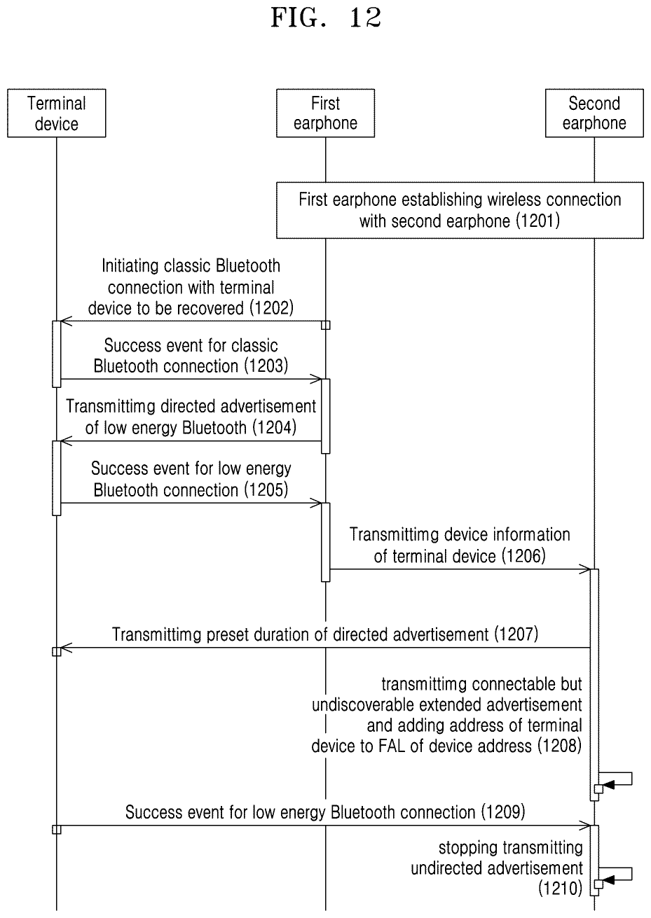

FIG. 12 is a diagram illustrating an example of a Bluetooth connection method of a wireless earphone in a recovery mode according to an embodiment of the present disclosure.

Referring to FIG. 12, in operation 1201, after the wireless earphone enter a working state (for example, fetching two earphones from an earphone case), if the two earphones are within a coverage range of a counterpart's wireless signal, a wireless connection (for example, but not limited to a Bluetooth connection) is established between the first earphone and the second earphone, and primary and secondary earphones are decided based on a preset rule. In this embodiment, it is described that the first earphone serves as the primary earphone; however, the present disclosure is not limited thereto. The second earphone can also serve as the primary earphone. It will be understood that the names of the first earphone and the second earphone may be exchanged.

Subsequently, the first earphone may decide whether to enter the recovery mode based on the scene. For example, in a case where the earphone case is opened and the wireless earphone has been paired with the terminal device previously, when it is detected that the wireless earphone is in the ear and no connection is established with the terminal device, or when the connection with the terminal device is abnormally disconnected, the first earphone enters the recovery mode.

If a “terminal device to be recovered” supports a classic Bluetooth connection, in operation 1202, the first earphone needs to actively initiate the classic Bluetooth connection with the “terminal device to be recovered.” In operation 1203, the first earphone receives a success event for the classic Bluetooth connection from the “terminal device to be recovered,” and the first earphone establishes the classic Bluetooth connection with the terminal device. Meanwhile, if the “terminal device to be recovered” supports a low energy Bluetooth connection, in operation 1204, the first earphone transmits a directed advertisement of the low energy Bluetooth, and a destination address is the “terminal device to be recovered.” In operation 1205, the first earphone receives a success event for the low energy Bluetooth connection, and the first earphone establishes the low energy Bluetooth connection with the terminal device.

After the first earphone establishes the low energy Bluetooth connection with the terminal device, in operation 1206, the first earphone transmits an address and an Identity Resolution Key of the terminal device to the second earphone through the wireless connection between the two earphones, and then enters a conventional mode. In the same or another embodiment, in operation 1206, the first earphone also transmits its connection status information to the second earphone.

In operation 1207, when the second earphone receives the address and Identity Resolution Key of the terminal device, since the second earphone also saves pairing information of the terminal device, the second earphone can transmit a preset duration of directed advertisement, to establish the low energy Bluetooth connection with the terminal device. Meanwhile, in operation 1208, the second earphone also transmits a connectable but undiscoverable extended advertisement (i.e., an undirected advertisement) and adds the address of the terminal device to a Filter Accept List of device address, to establish the low energy Bluetooth connection with the terminal device.

At this point, the terminal device actively establishes the low energy Bluetooth connection with the second earphone after scanning the undirected advertisement transmitted by the second earphone. In operation 1209, the second earphone successfully establishes the low energy Bluetooth connection with the terminal device, and receives a success event for the low energy Bluetooth connection. Subsequently, in operation 1210, since the second earphone has connected to the terminal device simultaneously with the first earphone, the second earphone stops transmitting the undirected advertisement.

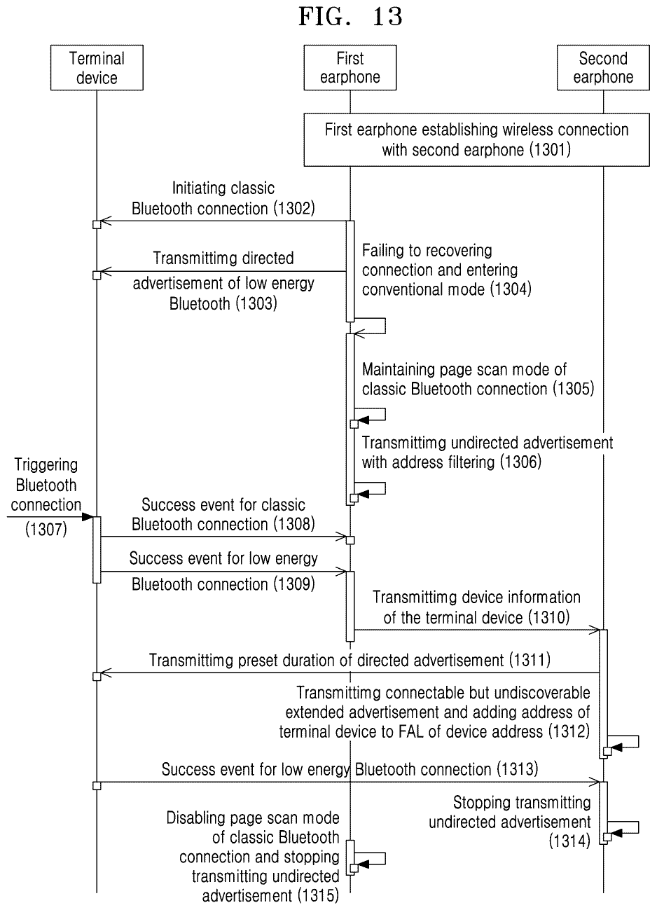

FIG. 13 is a diagram illustrating an example of a Bluetooth connection method of a wireless earphone in a conventional mode according to an embodiment of the present disclosure. FIG. 13 illustrates an example that the first earphone enters the conventional mode in a case where a Bluetooth connection with a “terminal device to be recovered” cannot be recovered in a recovery mode. However, the present disclosure is not limited thereto. When the wireless earphone fails to establish the Bluetooth connection with the terminal device in a pairing mode, or when the wireless earphone successfully establishes the Bluetooth connection with the terminal device in the pairing mode/recovery mode, the first earphone can also enter the conventional mode.

Referring to FIG. 13, in operation 1301, after the wireless earphone enters a working state (for example, fetching two earphones from an earphone case), if the two earphones are within a coverage range of a counterpart's wireless signal, a wireless connection (for example, but not limited to a Bluetooth connection) is established between the first earphone and the second earphone, and primary and secondary earphones are decided based on a preset rule. In this embodiment, it is described that the first earphone serves as the primary earphone; however, the present disclosure is not limited thereto. The second earphone can also serve as the primary earphone. It is understood that the names of the first earphone and the second earphone may be simply exchanged. Subsequently, the first earphone may decide whether to enter the recovery mode based on the scene. For example, in a case where the earphone case is opened and the wireless earphone has been paired with the terminal device previously, when it is detected that the wireless earphone is in the ear and no connection is established with the terminal device, or when the connection with the terminal device is abnormally disconnected, the first earphone enters the recovery mode.

If a “terminal device to be recovered” supports a classic Bluetooth connection, in operation 1302, the first earphone needs to actively initiate the classic Bluetooth connection with the “terminal device to be recovered.” Meanwhile, if the “terminal device to be recovered” supports a low energy Bluetooth connection, in operation 1303, the first earphone needs to transmit a directed advertisement of the low energy Bluetooth, and a destination address is the “terminal device to be recovered.”

If the first earphone fails to establish the Bluetooth connection with the “terminal device to be recovered” (e.g. connection timeout or failure), in operation 1304, the first earphone enters the conventional mode. In operation 1305, the first earphone disables an inquiry scan mode of the classic Bluetooth connection and enables/maintains a page scan mode of the classic Bluetooth connection.

At the same time, in operation 1306, the first earphone also transmits a connectable but undiscoverable extended advertisement (i.e., an undirected advertisement) and adds addresses of all terminal devices previously connected to it to a Filter Accept List of device address, to establish the low energy Bluetooth connection with respective terminal devices previously connected to it.

Therefore, if a user uses a terminal device that has previously established the Bluetooth connection with the wireless earphone to establish the Bluetooth connection with the wireless earphone, in operation 1307, the user can operate on the terminal device to initiate a Bluetooth connection process with the wireless earphone. If the terminal device successfully establishes the classic Bluetooth connection and the low energy Bluetooth connection with the wireless earphone, in operation 1308, the first earphone receives a success event for the classic Bluetooth connection, and in operation 1309, the first earphone receives a success event for the low energy Bluetooth connection. Subsequently, in operation 1310, the first earphone transmits an address and an Identity Resolution Key of the terminal device to the second earphone through the wireless connection between the two earphones. In embodiments, in operation 1310, the first earphone also transmits its connection status information to the second earphone.

Alternatively, if the first earphone determines that the number of terminal devices connected to it has reached a maximum number allowed for connection, in operation 1315, the first earphone disables a page scan mode of the classic Bluetooth connection and stops transmitting the undirected advertisement.

In operation 1311, when the second earphone receives the address and Identity Resolution Key of the terminal device, since the second earphone also saves pairing information of the terminal device, the second earphone can transmit a preset duration of directed advertisement, to establish the low energy Bluetooth connection with the terminal device. Meanwhile, in operation 1312, the second earphone can also transmit the connectable but undiscoverable extended advertisement (i.e., the undirected advertisement) and adds the address of the terminal device to the Filter Accept List of device address, to establish the low energy Bluetooth connection with the terminal device.

At this point, the terminal device actively establishes the low energy Bluetooth connection with the second earphone after scanning the undirected advertisement transmitted by the second earphone. In operation 1313, the second earphone successfully establishes the low energy Bluetooth connection with the terminal device, and receives the success event for the low energy Bluetooth connection. Subsequently, in operation 1314, since the second earphone has connected to the terminal device simultaneously with the first earphone, the second earphone stops transmitting the undirected advertisement.

FIG. 14 is a diagram illustrating an example of a Bluetooth connection method of a wireless earphone in a single earphone usage scenario according to an embodiment of the present disclosure.

Referring to FIG. 14, it details a scenario where a wireless connection between the earphones cannot be established, e.g., where two earphones are not in working mode at the same time or are not within a coverage range of each other's wireless signal. In this case, according to an embodiment of the present disclosure, a single earphone in the working state can also be used independently, that has an ability to establish a classic Bluetooth connection and a low energy Bluetooth connection with a terminal device.

Specifically, in operation 1401, after a first earphone enters the working state, the first earphone fails to establish a wireless connection with a second earphone (for example, but not limited to, only one earphone is fetched from an earphone case while the other earphone is not fetched out, or two earphones are fetched out but only one earphone is worn), and in operation 1402, the first earphone establishes the classic Bluetooth connection and the low energy Bluetooth connection with the terminal device. In this embodiment, it is described that the first earphone serves as the primary earphone; however, the present disclosure is not limited thereto. The second earphone can also serve as the primary earphone. It will be understood that the names of the first earphone and the second earphone may be simply exchanged.

In operation 1403, when the second earphone enters the working state or when the second earphone enters the coverage range of the wireless signal of the first earphone, the first earphone establishes the wireless connection with the second earphone. After establishing a connection with the second earphone, the first earphone, in operation 1404, transmits an address and an Identity Resolution Key of the terminal device to the second earphone through the wireless connection between the two earphones. In embodiments, in operation 1404, the first earphone also transmits its connection status information to the second earphone.

In operation 1405, when the second earphone receives the address and the Identity Resolution Key of the terminal device, if the second earphone saves pairing information of the terminal device, the second earphone can transmit a preset duration of directed advertisement to establish the low energy Bluetooth connection with the terminal device. At the same time, in operation 1406, the second earphone also transmits a connectable but undiscoverable extended advertisement (i.e., an undirected advertisement) and adds the address of the terminal device to a Filter Accept List of device address, to establish the low energy Bluetooth connection with the terminal device. Alternatively, if the second earphone has saved the pairing information of the terminal device, the second earphone can transmit the connectable but undiscoverable extended advertisement (i.e., the undirected advertisement) and add the address of the terminal device to the Filter Accept List of device address, to establish the low energy Bluetooth connection with the terminal device.

Once the terminal device actively establishes the low energy Bluetooth connection with the second earphone after scanning the undirected advertisement transmitted by the second earphone, or the second earphone successfully establishes the low energy Bluetooth connection with the terminal device, in operation 1407, the second earphone receives a success event for the low energy Bluetooth connection. Subsequently, in operation 1408, since the second earphone has connected to the terminal device simultaneously with the first earphone, the second earphone stops transmitting the undirected advertisement.

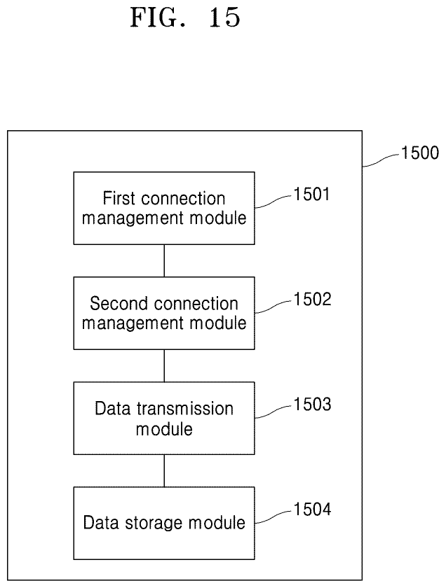

FIG. 15 is a block diagram illustrating a configuration of each of two earphones included in a wireless earphone according to an embodiment of the present disclosure.

Referring to FIG. 15, an earphone 1500 (i.e. each of the two earphones included in the wireless earphone) includes a first connection management module 1501 (also referred to herein as a first connection manager 1501), a second connection management module 1502 (also referred to herein as a second connection manager 1502), a data transmission module 1503 (also referred to herein as data transmitter 1503), and a data storage module 1504 (also referred to herein as data storage 1504).

The first connection manager 1501 can establish a wireless connection with another earphone (i.e. the first connection management module of the other earphone). When the earphone 1500 is determined as a primary earphone, the second connection manager 1502 can establish a first Bluetooth connection (i.e. a classic Bluetooth connection) and/or a second Bluetooth connection (i.e. a low energy Bluetooth connection) with a target terminal device. When the earphone 1500 is determined as a secondary earphone, the second connection manager 1502 can transmit a directed advertisement and a first undirected advertisement or transmit the first undirected advertisement based on device information of the target terminal device and connection status information of the primary earphone, to establish the second Bluetooth connection with the target terminal device.

The data transmitter 1503 can synchronize data with the other earphone. When the earphone 1500 is determined as the primary earphone, the data transmitter 1503 can also obtain the device information of the target terminal device and transmit the device information and the connection status information of the primary earphone to the other earphone. The data storage 1504 can store the device information. As described above, the device information includes an address and an Identity Resolution Key of the target terminal device. Alternatively, the data storage 1504 can also store pairing information of a terminal device.

According to an embodiment of the present disclosure, when the earphone 1500 is determined as the primary earphone, in response to a connection mode being a pairing mode, the second connection manager 1502 can enable an inquiry scan mode and a page scan mode of the earphone 1500 to establish the first Bluetooth connection with the target terminal device, and/or transmit a second undirected advertisement to establish the second Bluetooth connection with the target terminal device. On the other hand, in response to the connection mode being a recovery mode, the second connection manager 1502 can enable the page scan mode of the earphone 1500 to establish the first Bluetooth connection with the target terminal device, and/or transmit a preset duration of directed advertisement to establish the second Bluetooth connection with the target terminal device. At this point, a destination address of the directed advertisement is the address of the target terminal device.

Alternatively, in response to the earphone 1500 not successfully establishing the first Bluetooth connection and/or the second Bluetooth connection with the target terminal device, the second connection manager 1502 can disable the inquiry scan mode, stop transmitting the second undirected advertisement, and determine the number of all target terminal devices which have connected to the earphone 1500. Herein, the number of all target terminal devices which have connected to the earphone 1500 includes a sum of the number of the target terminal devices which have only established the first Bluetooth connection with the earphone 1500, the number of the target terminal devices which have only established the second Bluetooth connection with the earphone 1500, and the number of the target terminal devices which have established the first Bluetooth connection and the second Bluetooth connection with the earphone 1500. In response to the number of the target terminal devices which have connected to the earphone 1500 is less than a first threshold, the second connection manager 1502 can maintain the page scan mode to establish the first Bluetooth connection with respective target terminal devices previously connected to the earphone 1500, and/or transmit the first undirected advertisement and add addresses of the respective target terminal devices previously connected to the earphone 1500 to a Filter Accept List of device address, to establish the second Bluetooth connection with the respective target terminal devices previously connected to the earphone 1500.

In response to the number of the target terminal devices which have connected to the earphone 1500 reaching the first threshold, the second connection manager 1502 can determine a connection type between the earphone 1500 and respective connected target terminal devices. In response to the connection type between the earphone 1500 and at least one target terminal device being only the first Bluetooth connection, the second connection manager 1502 can transmit the first undirected advertisement and add address of the at least one target terminal device with which the second Bluetooth connection is not established to the Filter Accept List of device address, to establish the second Bluetooth connection with the at least one target terminal device with which the second Bluetooth connection is not established. In response to the connection type between the earphone 1500 and at least one target terminal device being only the second Bluetooth connection, the second connection manager 1502 can maintain the page scan mode to establish the first Bluetooth connection with the at least one target terminal device with which the first Bluetooth connection is not established. In response to the connection type between the earphone 1500 and the respective connected target terminal devices being the first Bluetooth connection and the second Bluetooth connection, the second connection manager 1502 can disable the page scan mode and stop transmitting the first undirected advertisement.

According to an embodiment of the present disclosure, when the earphone 1500 is determined as the secondary earphone, the second connection manager 1502 can determine whether having the pairing information of the target terminal device. In response to having the pairing information of the target terminal device, the second connection manager 1502 can transmit a preset duration of directed advertisement based on the pairing information, while transmit the first undirected advertisement and add the address of the target terminal device to the Filter Accept List of device address, to establish the second Bluetooth connection with the target terminal device. In response to having no the pairing information of the target terminal device, the second connection manager 1502 can transmit the first undirected advertisement and add the address of the target terminal device to the Filter Accept List of device address, to establish the second Bluetooth connection with the target terminal device.

Alternatively, the second connection manager 1502 can determine whether the second Bluetooth connection has been established with other terminal device. In response to not establishing the second Bluetooth connection with the other terminal device, the second connection manager 1502 can determine whether having the pairing information of the target terminal device. On the other hand, in response to establishing the second Bluetooth connection with the other terminal device, the second connection manager 1502 can determine whether the number of all target terminal devices connected to the earphone 1500 indicated by the connection status information reaches the first threshold. In response to the number of all target terminal devices connected to the earphone 1500 indicated by the connection status information reaching the first threshold, the second connection manager 1502 can disconnect the second Bluetooth connection with the other terminal device. In response to the number of all target terminal devices connected to the first earphone indicated by the connection status information being less than or equal to the first threshold, the second connection manager 1502 can maintain the second Bluetooth connection with other terminal device. Herein, after disconnecting the second Bluetooth connection with the other terminal device or after maintaining the second Bluetooth connection with the other terminal device, the second connection manager 1502 can determine whether having the pairing information of the target terminal device.

Alternatively, in response to establishing the second Bluetooth connection with the target terminal device, the second connection manager 1502 can stop transmitting the first undirected advertisement.

According to an embodiment of the present disclosure, in response to the earphone 1500 establishing the wireless connection with the other earphone and being selected as the primary earphone based on a preset rule, the second connection manager 1502 can establish the first Bluetooth connection and/or the second Bluetooth connection with the target terminal device. Alternatively, in response to the earphone 1500 establishing the wireless connection with the other earphone and being selected as the primary earphone based on a preset rule, the data transmitter 1503 can transmit the device information and the connection status information of the primary earphone to the other earphone.

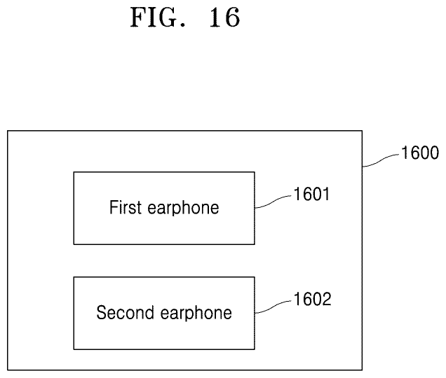

FIG. 16 is a block diagram illustrating a wireless earphone according to an embodiment of the present disclosure.

Referring to FIG. 16, the wireless earphone 1600 includes a first earphone 1601 and a second earphone 1602. The first earphone 1601 may establish a first Bluetooth connection (i.e. a classic Bluetooth connection) and/or a second Bluetooth connection (i.e. a low energy Bluetooth connection) with a target terminal device, and in response to establishing the second Bluetooth connection with the target terminal device, may obtain device information of the target terminal device, and transmit the device information and connection status information of the first earphone 1601 to the second earphone 1602. Herein, the device information includes an address and an Identity Resolution Key of the target terminal device. The second earphone 1602 may transmit a directed advertisement and a first undirected advertisement or transmit the first undirected advertisement based on the device information and the connection status information of the first earphone, to establish the second Bluetooth connection with the target terminal device.

In this embodiment, the first earphone may serve as the primary earphone; however, the present disclosure is not limited thereto. The second earphone can also serve as the primary earphone. In this case, it is simply that the names of the first earphone and the second earphone are exchanged.

According to an example embodiment of the present disclosure, there is also provided a computer readable storage medium storing computer executable instructions that, when executed by at least one processor, cause the at least one processor to execute a Bluetooth connection method of a wireless earphone according to the embodiment of the present disclosure. Examples of the computer readable storage medium include: read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), a card type memory such as multimedia card, secure digital (SD) card or extreme digital (XD) card, magnetic tapes, floppy disks, magneto-optical data storage devices, optical data storage devices, hard disks, solid-state disks, and any other device that is configured to store computer program and any associated data, data files, and data structures in a non-transitory manner and providing the computer program and any associated data, data files, and data structures to a processor or computer so that the processor or computer can execute the computer program. The instructions or computer program in the above-mentioned computer readable storage medium may run in an environment deployed in computer equipment such as a client, a host, an agent device, a server, etc. In addition, in one example, the computer program and any associated data, data files, and data structures are distributed over network-coupled computer systems so that the computer program and any associated data, data files, and data structures are stored, accessed, and executed in a distributed fashion by one or more processors or computers.

Any functional blocks shown in the accompanying drawings and described above may be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System on chip (SoC), a programmable logic unit, a microprocessor, application-specific integrated circuit (ASIC), etc.

The Bluetooth connection method of the wireless earphone and the wireless earphone according to embodiments of the present disclosure, is compatible with a terminal device that only supports the classic Bluetooth connection and a terminal device that only supports the low energy Bluetooth connection, as well as a dual-mode Bluetooth terminal device that supports both the classic and low energy Bluetooth connections, thereby improving the compatibility of a dual-mode TWS earphone.

On the other hand, according to the Bluetooth connection method of the wireless earphone and the wireless earphone according to embodiments of the present disclosure, when a secondary earphone has device information (i.e. pairing information) of the terminal device, it can quickly establish the low energy Bluetooth connection with the terminal device through a directed advertisement, thereby improving a connection speed and a success rate of connection between the secondary earphone and the terminal device.

Moreover, according to the Bluetooth connection method of the wireless earphone and the wireless earphone according to embodiments of the present disclosure, through an address filtering mechanism used by primary and secondary earphones when transmitting a low energy Bluetooth advertisement, as well as a mechanism that the secondary earphone checks and disconnects a terminal device that is not connected to the primary earphone, a consistency of the connection between the primary and secondary earphones and the terminal device can be ensured, thereby avoiding occurrence of a misconnection or a mixed connection.

Accordingly, an aspect of the present disclosure is directed to a Bluetooth connection method of a wireless earphone that includes a first earphone and a second earphone. The Bluetooth connection method may be executed by at least one processor and may include establishing at least one of a first Bluetooth connection or a second Bluetooth connection between a target terminal device and the first earphone; obtaining device information of the target terminal device in response to establishing the second Bluetooth connection between the target terminal device and the first earphone; transmitting the device information and connection status information of the first earphone to the second earphone; and transmitting a directed advertisement and a first undirected advertisement or transmitting the first undirected advertisement based on the device information and the connection status information, to establish the second Bluetooth connection between the target terminal device and the second earphone; wherein the device information comprises an address and an Identity Resolution Key of the target terminal device.

In an embodiment, the establishing of a first Bluetooth connection and/or a second Bluetooth connection with a target terminal device includes: in response to a connection mode being a pairing mode, enabling an inquiry scan mode and a page scan mode of the first earphone to establish the first Bluetooth connection with the target terminal device, and/or transmitting a second undirected advertisement to establish the second Bluetooth connection with the target terminal device, at the first earphone.

In an embodiment, the establishing of a first Bluetooth connection and/or a second Bluetooth connection with a target terminal device includes: in response to the connection mode being a recovery mode, actively initiating the first Bluetooth connection with the target terminal device and/or transmitting a preset duration of directed advertisement to establish the second Bluetooth connection with the target terminal device, at the first earphone, wherein a destination address of the directed advertisement is the address of the target terminal device.

In an embodiment, the Bluetooth connection method further includes: in response to the first earphone not successfully establishing the first Bluetooth connection and/or the second Bluetooth connection with the target terminal device, disabling the inquiry scan mode, stopping transmitting the second undirected advertisement, and determining the number of all target terminal devices which have connected to the first earphone, at the first earphone, wherein the number of all target terminal devices which have connected to the first earphone includes a sum of the number of the target terminal devices which have only established the first Bluetooth connection with the first earphone, the number of the target terminal devices which have only established the second Bluetooth connection with the first earphone, and the number of the target terminal devices which have established the first Bluetooth connection and the second Bluetooth connection with the first earphone; and in response to the number being less than a first threshold, maintaining the page scan mode to establish the first Bluetooth connection with respective target terminal devices previously connected to the first earphone, and/or transmitting the first undirected advertisement and adding addresses of the respective target terminal devices previously connected to the first earphone to a Filter Accept List of device address, to establish the second Bluetooth connection with the respective target terminal devices previously connected to the first earphone, at the first earphone.

In an embodiment, the Bluetooth connection method further includes: in response to the number reaching the first threshold, determining a connection type between the first earphone and respective connected target terminal devices, at the first earphone; in response to the connection type between the first earphone and at least one target terminal device being only the first Bluetooth connection, transmitting the first undirected advertisement and adding an address of the at least one target terminal device to the Filter Accept List of device address, to establish the second Bluetooth connection with the at least one target terminal device, at the first earphone; in response to the connection type between the first earphone and at least one target terminal device being only the second Bluetooth connection, maintaining the page scan mode to establish the first Bluetooth connection with the at least one target terminal device, at the first earphone.

In an embodiment, the Bluetooth connection method further includes: in response to the connection type between the first earphone and the respective connected target terminal devices being the first Bluetooth connection and the second Bluetooth connection, disabling the page scan mode and stopping transmitting the first undirected advertisement, at the first earphone.

In an embodiment, the transmitting of a directed advertisement and a first undirected advertisement or transmitting the first undirected advertisement based on the device information and the connection status information, to establish the second Bluetooth connection with the target terminal device, includes: determining whether having pairing information of the target terminal device, at the second earphone; in response to having the pairing information of the target terminal device, transmitting a preset duration of directed advertisement based on the pairing information, while transmitting the first undirected advertisement and adding an address of the target terminal device to a Filter Accept List of device address, to establish the second Bluetooth connection with the target terminal device, at the second earphone; and in response to having no pairing information of the target terminal device, transmitting the first undirected advertisement and adding the address of the target terminal device to the Filter Accept List of device address, to establish the second Bluetooth connection with the target terminal device, at the second earphone.

In an embodiment, the transmitting of a directed advertisement and a first undirected advertisement or transmitting the first undirected advertisement based on the device information and the connection status information, to establish the second Bluetooth connection with the target terminal device, further includes: determining whether the second Bluetooth connection has been established with other terminal device, at the second earphone; wherein in response to not establishing the second Bluetooth connection with the other terminal device, determining whether having the pairing information of the target terminal device, at the second earphone.

In an embodiment, the transmitting of a directed advertisement and a first undirected advertisement or transmitting the first undirected advertisement based on the device information and the connection status information, to establish the second Bluetooth connection with the target terminal device, further includes: in response to establishing the second Bluetooth connection with the other terminal device, determining whether the number of all target terminal devices connected to the first earphone indicated by the connection status information reaches a first threshold, at the second earphone; in response to the connection status information indicating that the number of all target terminal devices connected to the first earphone reaches the first threshold, disconnecting the second Bluetooth connection with the other terminal device, at the second earphone; and in response to the connection status information indicating that the number of all target terminal devices connected to the first earphone is less than or equal to the first threshold, maintaining the second Bluetooth connection with other terminal device, at the second earphone; wherein after disconnecting the second Bluetooth connection with the other terminal device or after maintaining the second Bluetooth connection with the other terminal device, determining whether having the pairing information of the target terminal device, at the second earphone.

In an embodiment, the transmitting of a directed advertisement and a first undirected advertisement or transmitting the first undirected advertisement based on the device information and the connection status information, to establish the second Bluetooth connection with the target terminal device, further includes: in response to establishing the second Bluetooth connection with the target terminal device, stopping transmitting the first undirected advertisement, at the second earphone.

In an embodiment, the establishing of a first Bluetooth connection and/or a second Bluetooth connection with a target terminal device includes: in response to establishing a wireless connection with the second earphone and being selected as a primary earphone based on a preset rule, establishing the first Bluetooth connection and/or the second Bluetooth connection with the target terminal device, at the first earphone.

In an embodiment, the transmitting of the device information and connection status information of the first earphone to the second earphone includes: in response to establishing a wireless connection with the second earphone and being selected as a primary earphone based on a preset rule, transmitting the device information and connection status information of the first earphone to the second earphone, at the first earphone.

The Bluetooth connection method of the wireless earphone and the wireless earphone according to embodiments of the present disclosure, is compatible with a terminal device that only supports a classic Bluetooth connection and a terminal device that only supports a low energy Bluetooth connection, as well as a dual-mode Bluetooth terminal device that supports both the classic and low energy Bluetooth connections, thereby improving the compatibility of a dual-mode TWS earphone.

Furthermore, according to the Bluetooth connection method of the wireless earphone and the wireless earphone according to embodiments of the present disclosure, when a secondary earphone has device information (i.e. pairing information) of the terminal device, it can quickly establish the low energy Bluetooth connection with the terminal device through a directed advertisement, thereby improving a connection speed and a success rate of connection between the secondary earphone and the terminal device.

Furthermore, according to the Bluetooth connection method of the wireless earphone and the wireless earphone according to embodiments of the present disclosure, through an address filtering mechanism used by primary and secondary earphones when transmitting a low energy Bluetooth advertisement, as well as a mechanism that the secondary earphone checks and disconnects a terminal device that is not connected to the primary earphone, a consistency of the connection between the primary and secondary earphones and the terminal device can be ensured, thereby avoiding an occurrence of a misconnection or a mixed connection.

While the present disclosure includes specific examples, it will be apparent to one of ordinary skill in the art that various changes in form and details may be made without departing from the spirit and scope of the claims and their equivalents. The examples disclosed herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the present disclosure is defined not by the detailed description, but by the claims and their equivalents, and all variations within the scope of the claims and their equivalents are to be construed as being included in the present disclosure.

What is claimed is:

1. A Bluetooth connection method of a wireless earphone comprising a first earphone and a second earphone, the Bluetooth connection method being executed by at least one processor, the Bluetooth connection method comprising:
establishing at least one of a first Bluetooth connection and a second Bluetooth connection between a target terminal device and the first earphone;
obtaining device information about the target terminal device based on establishing the second Bluetooth connection between the target terminal device and the first earphone;
transmitting the device information and connection status information about the first earphone to the second earphone; and
transmitting a directed advertisement and a first undirected advertisement or transmitting the first undirected advertisement based on the device information and the connection status information, to establish the second Bluetooth connection between the target terminal device and the second earphone;
wherein the device information comprises an address and an Identity Resolution Key of the target terminal device.

2. The Bluetooth connection method of the wireless earphone of claim 1, wherein the establishing of the first Bluetooth connection and the second Bluetooth connection between the target terminal device and the first earphone comprises:
based on a connection mode of the first earphone being a pairing mode, enabling an inquiry scan mode and a page scan mode of the first earphone to establish the first Bluetooth connection between the target terminal device and the first earphone; or
based on the connection mode of the first earphone being the pairing mode, transmitting a second undirected advertisement to establish the second Bluetooth connection between the target terminal device and the first earphone.

3. The Bluetooth connection method of the wireless earphone of claim 2, wherein the establishing of the first Bluetooth connection and the second Bluetooth connection between the target terminal device and the first earphone comprises:
based on the connection mode of the first earphone being a recovery mode, performing one or more of:
actively initiating the first Bluetooth connection with the target terminal device, and
transmitting a preset duration of directed advertisement to establish the second Bluetooth connection with the target terminal device,
wherein a destination address of the directed advertisement is the address of the target terminal device.

4. The Bluetooth connection method of the wireless earphone of claim 3, wherein the Bluetooth connection method further comprises:
based on the first earphone not successfully establishing the first Bluetooth connection or based on the first earphone not successfully establishing the second Bluetooth connection between the target terminal device and the first earphone, disabling the inquiry scan mode of the first earphone, stopping transmitting the second undirected advertisement, and determining a number of all target terminal devices which have connected to the first earphone, wherein the number of all target terminal devices which have connected to the first earphone comprises a sum of a first number of target terminal devices which have only established the first Bluetooth connection with the first earphone, a second number of the target terminal devices which have only established the second Bluetooth connection with the first earphone, and a third number of the target terminal devices which have established the first Bluetooth connection and the second Bluetooth connection with the first earphone; and
based on the number of all target terminal devices being less than a first threshold, performing one or more of:
maintaining the page scan mode of the first earphone to establish the first Bluetooth connection with respective target terminal devices previously connected to the first earphone, or
transmitting the first undirected advertisement and adding addresses of the respective target terminal devices previously connected to the first earphone to a Filter Accept List of device address, to establish the second Bluetooth connection with the respective target terminal devices previously connected to the first earphone.

5. The Bluetooth connection method of the wireless earphone of claim 4, wherein the Bluetooth connection method further comprises:
based on the number of all target terminal devices being greater than or equal to the first threshold, determining a connection type between the first earphone and respective connected target terminal devices;
based on the connection type between the first earphone and a first target terminal device among the respective connected target terminal devices being only the first Bluetooth connection, transmitting the first undirected advertisement and adding an address of the first target terminal device to the Filter Accept List of device address, to establish the second Bluetooth connection between the first target terminal device and the first earphone; and
based on the connection type between the first earphone and a second target terminal device respective connected target terminal devices being only the second Bluetooth connection, maintaining the page scan mode of the first earphone to establish the first Bluetooth connection between the second target terminal device and the first earphone.

6. The Bluetooth connection method of the wireless earphone of claim 5, wherein the Bluetooth connection method further comprises:
based on the connection type between the first earphone and the respective connected target terminal devices being the first Bluetooth connection and the second Bluetooth connection, disabling the page scan mode of the first earphone and stopping transmitting the first undirected advertisement.

7. The Bluetooth connection method of the wireless earphone of claim 1, wherein the transmitting of the directed advertisement and the first undirected advertisement or the transmitting the first undirected advertisement based on the device information and the connection status information, to establish the second Bluetooth connection between the target terminal device and the second earphone comprises:
determining whether the second earphone has pairing information about the target terminal device;
based on the second earphone having the pairing information about the target terminal device, transmitting a preset duration of directed advertisement based on the pairing information, while transmitting the first undirected advertisement and adding an address of the target terminal device to a Filter Accept List of device address, to establish the second Bluetooth connection between the target terminal device and the second earphone; and
based on the second earphone not having the pairing information about the target terminal device, transmitting the first undirected advertisement and adding the address of the target terminal device to the Filter Accept List of device address, to establish the second Bluetooth connection between the target terminal device and the second earphone.

8. The Bluetooth connection method of the wireless earphone of claim 7, wherein the transmitting of the directed advertisement and the first undirected advertisement or the transmitting the first undirected advertisement based on the device information and the connection status information, to establish the second Bluetooth connection between the target terminal device and the second earphone further comprises:
determining whether the second Bluetooth connection has been established between the target terminal device and the second earphone;
wherein based on not establishing the second Bluetooth connection between the target terminal device and the second earphone, it is determined that the second earphone does not have the pairing information about the target terminal device.

9. The Bluetooth connection method of the wireless earphone of claim 7, wherein the transmitting of the directed advertisement and the first undirected advertisement or the transmitting the first undirected advertisement based on the device information and the connection status information, to establish the second Bluetooth connection between the target terminal device and the second earphone further comprises:
based on establishing the second Bluetooth connection between another terminal device and the second earphone, determining whether a fourth number of all target terminal devices connected to the first earphone indicated by the connection status information reaches a first threshold;
based on the fourth number of all target terminal devices connected to the first earphone indicated by the connection status information reaching the first threshold, disconnecting the second Bluetooth connection between the another terminal device and the second earphone; and
based on the fourth number of all target terminal devices connected to the first earphone indicated by the connection status information being less than or equal to the first threshold, maintaining the second Bluetooth connection between the another terminal device and the second earphone;
wherein after disconnecting the second Bluetooth connection between the another terminal device and the second earphone or after maintaining the second Bluetooth connection between the another terminal device and the second earphone, it is determined whether the second earphone has the pairing information about the target terminal device.

10. The Bluetooth connection method of the wireless earphone of claim 7, wherein the transmitting of the directed advertisement and the first undirected advertisement or the transmitting the first undirected advertisement based on the device information and the connection status information, to establish the second Bluetooth connection between the target terminal device and the second earphone further comprises:
based on establishing the second Bluetooth connection between the target terminal device and the second earphone, stopping the transmitting of the first undirected advertisement.

11. The Bluetooth connection method of the wireless earphone of claim 1, wherein the establishing of at least one of the first Bluetooth connection and the second Bluetooth connection between the target terminal device and the first earphone comprises:
based on establishing a wireless connection with the second earphone and being selected as a primary earphone based on a preset rule, establishing the first Bluetooth connection or the second Bluetooth connection between the target terminal device and the first earphone.

12. The Bluetooth connection method of the wireless earphone of claim 1, wherein the transmitting of the device information and the connection status information about the first earphone to the second earphone comprises:
based on establishing a wireless connection with the second earphone and being selected as a primary earphone based on a preset rule, transmitting the device information and the connection status information about the first earphone to the second earphone.

13. A wireless earphone comprising a first earphone and a second earphone, wherein the first earphone comprises at least one first processor and the at least one first processor is configured to:
establish at least one of a first Bluetooth connection and a second Bluetooth connection between a target terminal device and the first earphone;
in response to establishing the second Bluetooth connection with the target terminal device, obtain device information about the target terminal device; and
transmit the device information and connection status information about the first earphone to the second earphone; and
the second earphone comprises at least one second processor and the at least one second processor is configured to:
transmit a directed advertisement and a first undirected advertisement or transmit the first undirected advertisement based on the device information and the connection status information, to establish the second Bluetooth connection between the target terminal device and the second earphone,
wherein the device information comprises an address and an Identity Resolution Key of the target terminal device.

14. The wireless earphone of claim 13, wherein, when establishing the first Bluetooth connection or the second Bluetooth connection between the target terminal device and the first earphone, the at least one first processor is configured to:
based on a connection mode of the first earphone being a pairing mode, enable an inquiry scan mode and a page scan mode of the first earphone to establish the first Bluetooth connection between the target terminal device and the first earphone; or
based on the connection mode of the first earphone being the pairing mode, transmit a second undirected advertisement to establish the second Bluetooth connection between the target terminal device and the first earphone.

15. The wireless earphone of claim 14, wherein, when establishing the first Bluetooth connection or the second Bluetooth connection between the target terminal device and the first earphone, the at least one first processor is configured to:
based on the connection mode of the first earphone being a recovery mode, perform one or more of:
actively initiating the first Bluetooth connection with the target terminal device, or
transmitting a preset duration of directed advertisement to establish the second Bluetooth connection with the target terminal device,
wherein a destination address of the directed advertisement is the address of the target terminal device.

16. The wireless earphone of claim 15, wherein the at least one first processor is configured to:
based on the first earphone not successfully establishing the first Bluetooth connection or based on the first earphone not successfully establishing the second Bluetooth connection between the target terminal device and the first earphone, disable the inquiry scan mode of the first earphone, stop transmitting the second undirected advertisement, and determine a number of all target terminal devices which have connected to the first earphone, wherein the number of all target terminal devices which have connected to the first earphone comprises a sum of a first number of target terminal devices which have only established the first Bluetooth connection with the first earphone, a second number of the target terminal devices which have only established the second Bluetooth connection with the first earphone, and a third number of the target terminal devices which have established the first Bluetooth connection and the second Bluetooth connection with the first earphone; and
based on the number of all target terminal devices being less than a first threshold, perform one or more of:
maintaining the page scan mode of the first earphone to establish the first Bluetooth connection with respective target terminal devices previously connected to the first earphone, and
transmitting the first undirected advertisement and adding addresses of the respective target terminal devices previously connected to the first earphone to a Filter Accept List of device address, to establish the second Bluetooth connection with the respective target terminal devices previously connected to the first earphone.

17. The wireless earphone of claim 16, wherein the at least one first processor is configured to:
based on the number of all target terminal devices being greater than or equal to the first threshold, determine a connection type between the first earphone and respective connected target terminal devices;
based on the connection type between the first earphone and a first target terminal device among the respective connected target terminal devices being only the first Bluetooth connection, transmit the first undirected advertisement and add an address of the first target terminal device to the Filter Accept List of device address, to establish the second Bluetooth connection between the first target terminal device and the first earphone; and
based on the connection type between the first earphone and a second target terminal device respective connected target terminal devices being only the second Bluetooth connection, maintain the page scan mode of the first earphone to establish the first Bluetooth connection between the second target terminal device and the first earphone.

18. The wireless earphone of claim 13, wherein, when transmitting the directed advertisement and the first undirected advertisement or transmitting the first undirected advertisement based on the device information and the connection status information, to establish the second Bluetooth connection between the target terminal device and the second earphone, the at least one second processor is configured to:
determine whether the second earphone has pairing information about the target terminal device;
based on the second earphone having the pairing information about the target terminal device, transmit a preset duration of directed advertisement based on the pairing information, while transmitting the first undirected advertisement, and add an address of the target terminal device to a Filter Accept List of device address, to establish the second Bluetooth connection between the target terminal device and the second earphone; and
based on the second earphone not having the pairing information about the target terminal device, transmit the first undirected advertisement, and add the address of the target terminal device to the Filter Accept List of device address, to establish the second Bluetooth connection between the target terminal device and the second earphone.

19. The wireless earphone of claim 13, wherein the at least one second processor is further configured to:
based on establishing the second Bluetooth connection between another terminal device and the second earphone, determine whether a fourth number of all target terminal devices connected to the first earphone indicated by the connection status information reaches a first threshold;
based on the fourth number of all target terminal devices connected to the first earphone indicated by the connection status information reaching the first threshold, disconnect the second Bluetooth connection between the another terminal device and the second earphone; and
based on the fourth number of all target terminal devices connected to the first earphone indicated by the connection status information being less than or equal to the first threshold, maintain the second Bluetooth connection between the another terminal device and the second earphone;
wherein after disconnecting the second Bluetooth connection between the another terminal device and the second earphone or after maintaining the second Bluetooth connection between the another terminal device and the second earphone, it is determined whether the second earphone has the pairing information about the target terminal device.

20. A wireless earphone comprising two earphones, wherein each of the two earphones comprises:
a first connection manager configured to: establish a wireless connection between a current earphone and another earphone;
a second connection manager configured to:
establish at least one of a first Bluetooth connection and a second Bluetooth connection between a target terminal device and the current earphone,
based on the current earphone being determined as a primary earphone and the another earphone being determined as a secondary earphone, transmit a directed advertisement and a first undirected advertisement or transmit the first undirected advertisement based on device information about the target terminal device and connection status information about the primary earphone, to establish the second Bluetooth connection between the target terminal device and the another earphone;
a data transmitter configured to:
synchronize data with the another earphone, and
obtain the device information about the target terminal device and transmit the device information and the connection status information about the primary earphone to the another earphone, based on the current earphone being determined as the primary earphone; and
a data storage configured to: store the device information, the device information comprising an address and an Identity Resolution Key of the target terminal device.
